(19) United States
(12) Patent Application Publication
(10) Pub. No.: US 2026/0282087 A1
(43) Pub. Date: Sep. 17, 2026

(54) CHANNEL UTILIZATION INFORMATION FOR AN OPERATING BANDWIDTH

(71) Applicant: QUALCOMM Incorporated, San Diego, CA (US)

(72) Inventor: Mahendran P, Chennai (IN)

(21) Appl. No.: 19/078,657

(22) Filed: Mar. 13, 2025

(51) Int. Cl. H04W 74/0816; H04W 60/04; H04W 76/10

(52) U.S. Cl. CPC H04W 74/0816; H04W 60/04; H04W 76/10

(57) ABSTRACT

This disclosure provides methods, components, devices and systems for providing and using channel utilization information (CUI) which includes CUI for the primary channel and granular level CUI for each secondary channel in an operating bandwidth. In some aspects, a network device may use the CUI to improve the performance of any combination of a device association process, an operating bandwidth reduction process or a process to select an optional primary channel in a non-primary channel access (NPCA) scheme, among other device and network actions.

### TECHNICAL FIELD

This disclosure relates generally to wireless communication, and more specifically, to providing channel utilization information (CUI) for each primary and secondary channel in an operating bandwidth to improve wireless communication device operation and wireless communication network performance.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless station (STA). The wireless station (STA) includes a processing system that includes processor circuitry and memory circuitry that stores code, the processing system configured to cause the wireless STA to receive, from a wireless access point (AP), a message including channel utilization information (CUI) for a primary channel and one or more secondary channels of an operating bandwidth associated with the wireless AP. The processing system is also configured to cause the wireless STA to perform one or more of: transmit, to the wireless AP, an association request in accordance with the CUI, communicate, with the wireless AP, using a reduced operating bandwidth in accordance with the CUI, and communicate, with the wireless AP, using one of the secondary channels as an optional primary channel in accordance with a non-primary channel access (NPCA) scheme and in accordance with the CUI.

In some examples, the message includes a quality of service basic service set (QBSS) load element that includes: a first field, interpretable by legacy wireless STAs, that contains the CUI for the primary channel, and one or more second fields, interpretable by non-legacy wireless STAs and not by the legacy wireless STAs, that contain the CUI for the one or more secondary channels. In some examples, the QBSS load element further includes a third field, interpretable by the non-legacy wireless STAs and not by the legacy wireless STAs, that contains aggregate CUI for the operating bandwidth.

In some examples of the wireless STA, the one or more second fields include a respective field for each of: a 40 MHz channel bandwidth of the operating bandwidth, an 80 MHz channel bandwidth of the operating bandwidth, a 160 MHz channel bandwidth of the operating bandwidth, and a 320 MHz channel bandwidth of the operating bandwidth.

In some aspects, transmitting the association request in accordance with the CUI further includes transmitting, to the wireless AP, the association request in accordance with the CUI satisfying a threshold or in accordance with a metric associated with the CUI being greater than a second metric associated with second CUI received from a second wireless AP.

In some examples of the wireless STA, the reduced operating bandwidth excludes at least one of the one or more secondary channels, and communicating, with the wireless AP, using the reduced operating bandwidth in accordance with the CUI further includes communicating using the reduced operating bandwidth in accordance with the CUI for the primary channel, the CUI for the one or more secondary channels, and an aggregate CUI indicating that an improvement in utilization associated with communicating using all of the one or more secondary channels in the operating bandwidth is below a threshold.

In some aspects, the techniques described herein relate to the wireless STA, where: the optional primary channel includes a secondary channel of the one or more secondary channels, and communicating, with the wireless AP, using one of the secondary channels as the optional primary channel in accordance with the NPCA scheme and in accordance with the CUI further includes communicating, with the wireless AP, using the secondary channel in accordance with the CUI for the primary channel and the CUI for the one or more secondary channel indicating that the secondary channel is associated with higher network performance than the primary channel.

Another innovative aspect of the subject matter described in this disclosure can be implemented in a method for wireless communication by a wireless STA. The method includes receiving, from a wireless access point (AP), a message including channel utilization information (CUI) for a primary channel and one or more secondary channels of an operating bandwidth associated with the wireless AP. The method also includes performing one or more of: transmitting, to the wireless AP, an association request in accordance with the CUI, communicating, with the wireless AP, using a reduced operating bandwidth in accordance with the CUI, and communicating, with the wireless AP, using one of the secondary channels as an optional primary channel in accordance with a non-primary channel access (NPCA) scheme and in accordance with the CUI.

In some aspects, the techniques described herein relate to a method, where the message includes a quality of service basic service set (QBSS) load element that includes: a first field, interpretable by legacy wireless STAs, that contains the CUI for the primary channel, and one or more second fields, interpretable by non-legacy wireless STAs and not by the legacy wireless STAs, that contain the CUI for the one or more secondary channels.

Another innovative aspect of the subject matter described in this disclosure can be implemented in a wireless access point (AP). In some aspects, the wireless AP includes a processing system that includes processor circuitry and memory circuitry that stores code, the processing system configured to cause the wireless AP to provide a message to a wireless station (STA), where the message includes channel utilization information (CUI) for a primary channel and one or more secondary channels of an operating bandwidth associated with the wireless AP. The processing system is also configured to cause the wireless AP to: perform one or more of: establish a network connection to the wireless STA using an association request received from the wireless STA in accordance with the CUI, communicate, with the wireless STA, using a reduced operating bandwidth in accordance with the CUI, and communicate, with the wireless STA, using one of the secondary channels as an optional primary channel in accordance with a non-primary channel access (NPCA) scheme and in accordance with the CUI.

Another innovative aspect of the subject matter described in this disclosure can be implemented in a method for wireless communication by a wireless (AP). The method includes providing a message to a wireless station (STA), where the message includes channel utilization information (CUI) for a primary channel and one or more secondary channels of an operating bandwidth associated with the wireless AP. The method also includes performing one or more of: establishing a network connection to the wireless STA using an association request received from the wireless STA in accordance with the CUI, communicating, with the wireless STA, using a reduced operating bandwidth in accordance with the CUI, and communicating, with the wireless STA, using one of the secondary channels as an optional primary channel in accordance with a non-primary channel access (NPCA) scheme and in accordance with the CUI.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a pictorial diagram of an example wireless communication network arrangement for providing channel utilization information for an operating bandwidth.

FIG. 5 shows a pictorial diagram of a frequency band with operating bandwidths.

FIG. 6A shows an example quality of service basic service set (QBSS) load element usable for providing channel utilization information for primary and secondary channels to network devices.

FIG. 6B shows an example quality of service basic service set (QBSS) load element usable for providing channel utilization information for primary and secondary channels to network devices.

FIG. 7 shows a pictorial diagram of a frequency band with a reduced operating bandwidth.

FIG. 8 shows a pictorial diagram of a frequency band with an optional primary channel.

FIG. 9 shows a flowchart illustrating an example process performable by or at a wireless station (STA) that supports providing channel utilization information (CUI) for each primary and secondary channel in an operating bandwidth to improve wireless communication device operation and wireless communication network performance.

FIG. 10 shows a flowchart illustrating an example process performable by or at a wireless access point (AP) that supports providing CUI for each primary and secondary channel in an operating bandwidth to improve wireless communication device operation and wireless communication network performance.

FIG. 11 shows a block diagram of an example wireless communication device 1100 that supports providing CUI for each primary and secondary channel in an operating bandwidth to improve wireless communication device operation and wireless communication network performance.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3^{rd} Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, the types of wireless communication devices and number of devices connected to the wireless communication networks continue to increase. Additionally, individual communication devices also commonly require increasing amounts of network resources including network bandwidth. For example, applications running on wireless communication devices in an enterprise Wi-Fi network may include applications with high-demands on network resources including video conferencing, cloud access applications, IoT applications and other similar applications. In some example wireless communication networks, including 802.11be (also referred to as Wi-Fi 7), 802.11bf, and 802.11bn (also referred to as Wi-Fi 8)) networks, bonded frequency channels provide an operating bandwidth which may provide higher throughput for these various high-demand applications and devices. In some examples, a wireless communication device, such as an access point (AP) may determine or select an operating or operational bandwidth for connected stations (STA) and select a range of channels within a band to provide that operating bandwidth. For example, the AP 102 may select sixteen 20 MHz channels that collectively span an operating bandwidth of 320 MHz. In some examples, such as Wi-Fi 8 networks, a non-primary channel access (NPCA) scheme also may be used to allow wireless communication devices to utilize non-primary or secondary channels in the operating bandwidth when a primary channel is occupied, busy, or otherwise congested with network traffic. In some implementations, the wireless communication networks may access non-primary or secondary channels using limited information of the congestion conditions across all channels. In some examples, wireless communications devices may operate in the NPCA scheme to provide better throughput or other benefit for an individual device, but result in an unbalanced overall wireless network as well expending unnecessary amounts of power resources and network resources.

Various aspects relate generally to wireless communication and providing and using channel utilization information (CUI) which includes CUI for each primary and secondary channel. Some aspects more specifically relate to providing CUI to wireless stations (STAs) from a wireless AP for each primary and secondary channel in an operating bandwidth to improve network device operation and overall network performance. In some examples, CUI includes network traffic congestion information for respective frequency channel(s), including a level or percentage of channel utilization for the respective frequency channel. In some aspects, a wireless STA may receive CUI in a message from a wireless AP. In some examples, the message with the CUI is a quality of service basic service set (QBSS) load element and includes fields interpretable by legacy wireless STAs and additional fields interpretable by non-legacy wireless STAs. In some aspects, the CUI includes CUI for a primary channel in an operating bandwidth associated with the wireless AP and additional CUI for each secondary channel in the operating bandwidth. In some examples, the CUI also may include an aggregate CUI representing channel conditions across the entire operating bandwidth.

In some aspects, the wireless STA may use the CUI to select and perform various actions to update the operation of the wireless STA and a network connection. For example, the wireless STA may use the CUI from the wireless AP to determine whether to connect to or associate with the wireless AP. For example, the CUI may satisfy a threshold for connection indicating a network connection established between the wireless STA and the AP provides an adequate connection for the wireless STA and does not cause over degradation of the overall wireless communication network. In some examples, the CUI may also be compared to CUI received from a second wireless AP, where the wireless STA selects an AP that provides a best network connection for the wireless STA and balanced network conditions overall.

In some aspects, the wireless STA may also use the CUI to update device and network connection operations. For example, the wireless STA may initiate a reduction in the operating bandwidth used to communicate with the wireless AP when the CUI indicates that an expanded operating bandwidth does not provide comparative improvements in network performance. In some examples, the wireless STA may also use the CUI in an NPCA scheme in order to select and communicate via a temporary primary channel from the secondary channels when the primary channel is congested or otherwise degraded.

Particular aspects of the subject matter described in this disclosure can be implemented to realize one or more of the following potential advantages. Providing CUI to network devices for each primary and secondary channel in an operating bandwidth provides for a more granular level of network conditions at a receiving device such that STAs are able to make more informed decisions in connecting to a network or AP and operating the network connections. In some examples, by using the QBSS load element with fields interpretable by legacy wireless STAs and additional fields interpretable by non-legacy wireless STAs, the CUI may be provided with backward compatibility such that legacy devices may still be utilized in a network and non-legacy devices will be able to take advantage of the additional granular level CUI. The aggregate CUI representing channel conditions across the entire operating bandwidth also provides both additional granular information for the operating bandwidth and serves as a quick-reference or summary of the network conditions for the operating bandwidth.

In some examples, the granular CUI for the secondary channels and the quick-reference summary aggregate CUI provide for STAs to enable quick decisions and more informed decisions for some device and network connection actions. For example, the CUI, including the secondary channel CUI and the aggregate CUI, provides a complete representation of the channel utilization and network traffic congestion in the operating bandwidth to the STA on whether to connect to or associate with a wireless AP or an alternate AP that also provides CUI. In some examples, the CUI may also enable reducing device and network resource usage when the STA reduces the operating bandwidth when the CUI indicates a wider operating bandwidth does not provide comparative improvements in the network or device performance. In some examples, the wireless STA also uses the CUI to improve the selection of an optional primary channel in the NPCA scheme since the STA may select a secondary channel with the highest network performance according to the CUI for the secondary channels. In some examples, the selection of the optional primary channel in the NPCA scheme enables improved performance for applications on executing on the wireless station including improved throughput and latency for network traffic to and from the wireless STA. In some examples, the aggregate CUI may also serve as a quick-reference for overall congestion of the operating bandwidth in deciding whether to connect to or associate with the wireless AP, whether to reduce the operating bandwidth and in the selection of the optional primary channel, enabling fast decisions at the STA.

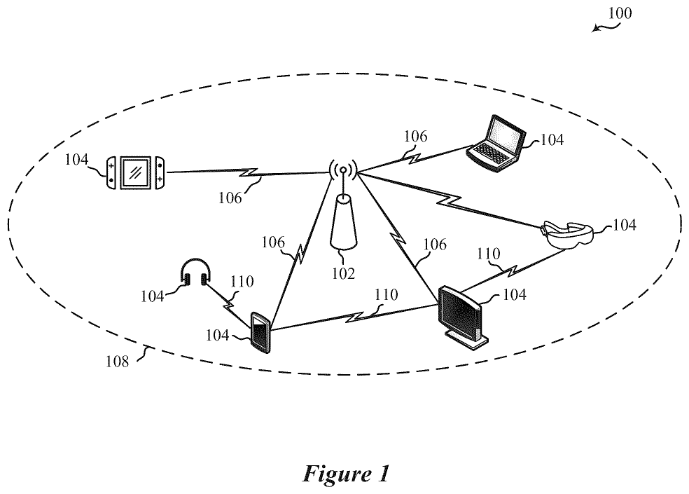

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (for example, detects, identifies, ascertains, or calculates), in association with a contention operation, that one or more 20 MHz subchannels of a wider bandwidth wireless channel are busy or otherwise not available, the transmitting device implements puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

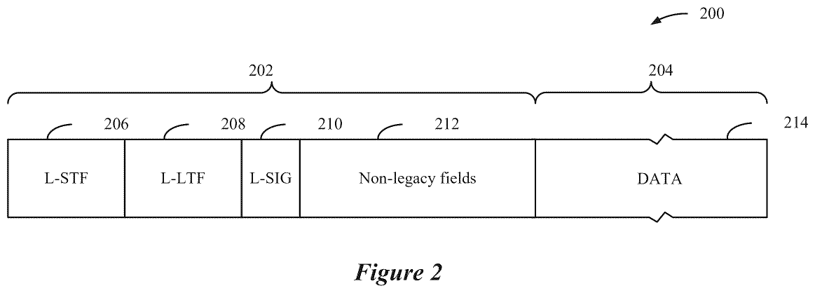

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

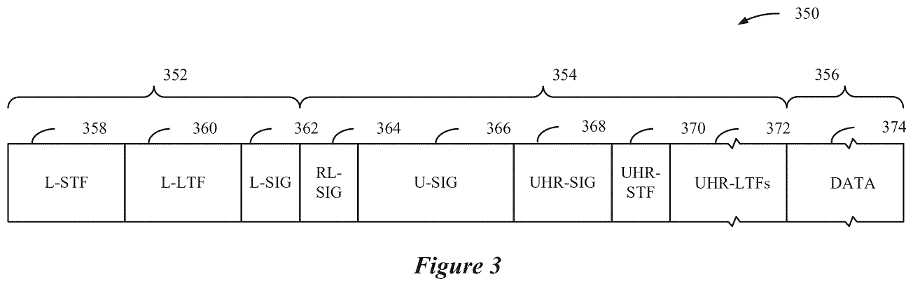

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is an UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (for example, STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, such as 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (for example, a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (for example, a STA identifier subfield within the version-dependent portion of the U-SIG 366) of an intended receiver of the PPDU. In some examples, an ELR PPDU 350 may include an ELR-signature (ELR-SIG) field that includes an uplink/downlink indicator subfield, a length subfield, a coding indicator subfield, and a modulation and coding scheme (MCS) subfield.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields).

In some wireless communications systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the UHR-SIG field for a UHR PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of UHR-SIG can be used to individually allocate RUs to the single user, thereby avoiding the punctured channels. In some other examples, U-SIG may be used to indicate SU preamble puncturing. For example, the SU preamble puncturing may be indicated by a value of the UHR-SIG compression field in U-SIG.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

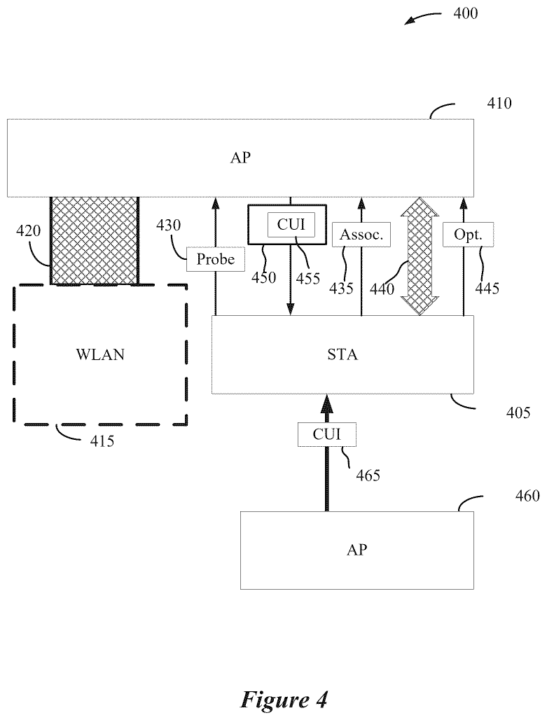

FIG. 4 shows a pictorial diagram of an example wireless communication network arrangement 400 for providing channel utilization information for an operating bandwidth. The wireless communication network arrangement 400 includes STA 405, AP 410 and AP 460 in a WLAN 415. In some implementations the STA 405 and the AP 410, along with additional network components shown in FIG. 4, provide or utilize CUI for each primary and secondary channel in an operating bandwidth to improve wireless communication device operation and wireless network performance for the WLAN 415. In some examples, the AP 410 and the AP 460 are APs for a wireless network such as the WLAN 415. In some examples, the AP 410 is a wireless AP such as one of the APs 102 described with reference to FIG. 1. In some examples, the WLAN 415 is a wireless communication network such as the wireless communication network 100 described with reference to FIG. 1. In some examples, the WLAN 415 may include numerous wireless communication devices including the AP 410, the AP 460 and additional APs such as additional wireless APs 102 and any number of client devices such as wireless STAs 104 described with reference to FIG. 1.

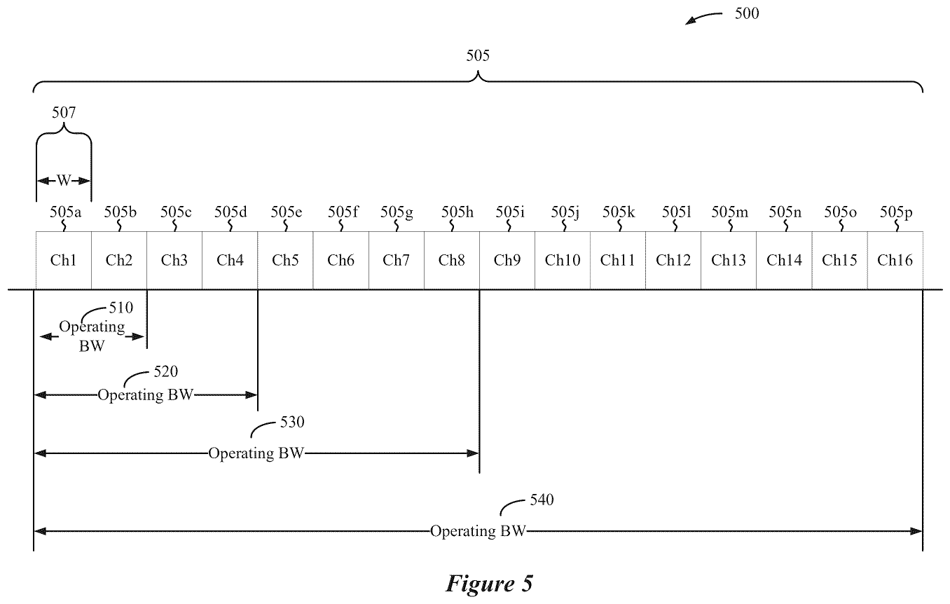

In some examples, the WLAN 415 may contain a large amount of STAs and other network devices communicating on a shared operating frequency. For example, the WLAN 415 may be an enterprise network where the APs 410 and 460 and STA 405 are communicating in multiple different bonded channels or operating bandwidths. In some examples, multiple operating bandwidths in the enterprise network provide support for connecting many client devices or STAs with individual high bandwidth requirements operating in the WLAN 415. The WLAN 415 may also be a mesh network where multiple APs, such as the AP 410 and AP 460, are available to provide communication links to individual STAs, such as the STA 405. In some mesh networks, the APs 410 and 460 and STA 405 interact to provide network balancing by steering individual STAs to an AP that provides improved network connectivity to the STA and network load balancing across the mesh network. In some examples, the WLAN 415 may also be a public network in a high density network environment. For example, the public network may be an area with a high density of people, such as airports, stadiums, conference centers and other similar environments, where the high density of people results in a high density of wireless network devices. In each example network implementation, including enterprise, mesh and public networks, the WLAN 415, including the AP 410, may provide bonded channels or operating bandwidths to client devices/STAs, including the STA 405, to provide for high throughput network connections to the STA 405 in the WLAN 415. For example, the AP 410 may determine or select an operating bandwidth for STAs, including the STA 405, in its BSS in the WLAN 415 and select a range of channels within a frequency band to provide that operating bandwidth. Additional examples of an operating bandwidth are described in more detail with reference to FIG. 5.

In some examples, wireless communications networks that provide for bonded channels or operating bandwidths, including the WLAN 415, may provide higher throughput and network performance for individual devices/clients/STAs, including the STA 405, in the network, but may also result in unbalanced networks or limited STA performance on the operating bandwidth. For example, network congestion and channel utilization information provided to STAs, such as the STA 405, in the wireless communication network may be limited for secondary channels in an operating bandwidth. For example, messages, such as management frames, sent to the STA 405 from the APs 410 and 460 in the WLAN 415 may include limited channel utilization information for a primary channel in the operation bandwidth, but not include detail channel utilization information for the non-primary or secondary channels in an operating bandwidth. For example, a message that includes a QBSS Load Element provided to STA 405 in the WLAN 415 may include only utilization information for a single channel, such as a primary 20 MHz channel in the operating bandwidth, where the frequency band wide utilization of the remaining channels in the operating bandwidth is not reported or is otherwise unknown to the receiving STAs, including the STA 405.

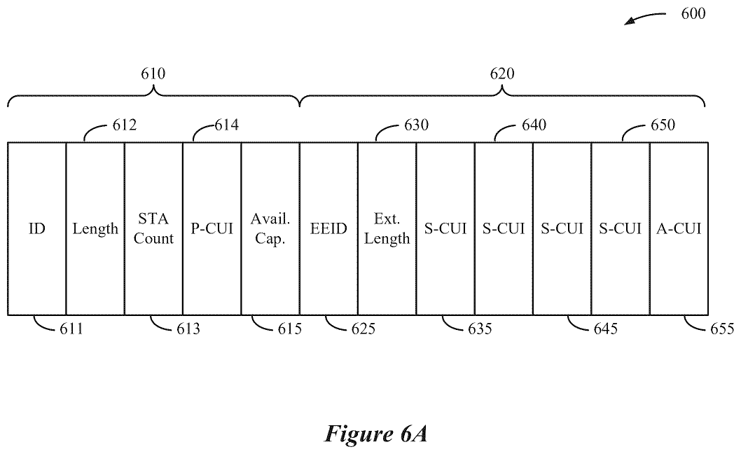

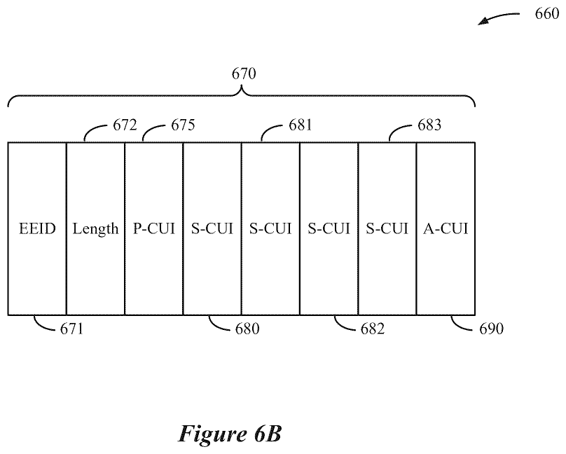

In some implementations described herein, the APs 410 and 460 in the WLAN 415 provide or report utilization metrics for each bonded 20 MHz sub-channel in a message to STAs, such as STA 405. For example, the AP 410 provides a message 450 to STAs in the WLAN 415, including the STA 405. In some examples, the message 450 includes CUI 455. In some examples, the message 450 is or includes a QBSS Load Element or extended QBSS load element. In some examples, the QBSS load element includes the utilization metrics, such as the CUI 455, for each bonded 20 MHz sub-channel in an operating bandwidth in various fields described herein in more detail with reference to FIGS. 6A and 6B.

In some examples, a subset of STAs, including the STA 405, in the WLAN 415 are legacy STAs which may not be able to operate using an operating bandwidth/bonded channels or process an extended QBSS load element. In some examples, the QBSS load element provided by the AP 410 includes a backward compatible structure, where the legacy clients/STAs may read/interpret legacy fields in the load element and non-legacy clients/STAs may read/interpret additional fields reporting the additional utilization information such as the CUI 455. In some examples, the CUI 455 includes secondary channel utilization information for each additional channel in an operating bandwidth, such as channel utilization information for each bonded 20 MHz channel. In some examples, the CUI 455 also includes an aggregate utilization which represents channel utilization of the total operating bandwidth. The messages providing CUI, including legacy fields, non-legacy fields, and various fields reporting CUI are described in more detail herein with reference to FIGS. 6A and 6B.

In some examples, the APs in the WLAN 415, including the AP 410 and the AP 460 provide CUI 455 for primary and secondary channels in an operating bandwidth in messages to the STA 405 in the WLAN 415. For example, the message 450 is or is included as a part of beacon frames or probe responses to the STA 405. In some examples, the STA 405 reads/interprets the message 450, including beacon frame/probe response frames, and assesses the CUI 455 for the operating bandwidth. In some implementations, the STA 405 utilizes the CUI 455 to select and perform various STA actions. In some examples, the STA 405 may have an active communication link to the AP 410, such as communication link 440. In some examples, the STA 405 may not have an active communication link or be associated with the AP until an association or link establishment process is performed as described herein.

In some examples, the AP 410 and the AP 460 collect or compile CUI for each frequency channel in an operating frequency band associated with the WLAN 415. In some examples, the AP 410 may operate in one or more frequency bands such as the 2.4 GHz, 5 GHz, 6 GHz, 45 GHz, or 60 GHz bands and collect CUI representing network activity and other information on each frequency channel of a given operating frequency. For example, the AP 410 and the STA 405 may both communicate and operate in at least one frequency band, such as frequency band 420, where the AP 410 monitors and collects CUI for each frequency channel in the frequency band 420. The AP 410 provides the collected CUI for the frequency band 420 or for an operating bandwidth subset to the STA 405 as the CUI 455. In some examples, the AP 460 also monitors and collects CUI for the frequency band 420 and provides CUI 465 to the STA 405 via a message similar to the message 450 or other similar means.

In some implementations, the STA 405 communicates with the AP 410 and AP 460 prior to establishing a link or associating with a given AP. For example, the STA 405 may send or transmit a probe request frame 430 to the AP 410, where the AP 410 sends the message 450 as a probe response frame with the CUI 455. In some examples, the STA 405 evaluates the CUI to determine whether a connection or communication link to the AP 410 would provide a sufficient network connection for the expected network connection performance at the STA 405. For example the STA 405 may determine whether a communication link to the AP with an operating bandwidth would satisfy a threshold for a network performance metric(s) such as throughput, quality of service (QoS), congestion, reliability or other similar network performance metrics. In some examples, the STA 405 may also evaluate the CUI and the network performance metric(s) associated with the CUI 455 as compared to a second network performance metric(s) associated with CUI 465 received from the AP 460. In some examples, the STA 405 may determine that CUI 455 indicates the threshold for the network performance metrics are met or provides for better network performance than the CUI 465 and sends/transmits an association request 435 in accordance with the CUI 455 to the AP 410 to establish a communication link 440 with an operating bandwidth.

In some implementations, the STA 405 may also evaluate whether updates to a communication link 440 may improve device performance or resource conservation. For example, the STA 405 may update the communication link 440 in order to communicate with the AP 410 using a reduced operating bandwidth in accordance with the CUI. For example, the STA 405 may determine from the CUI 455 that the operating bandwidth may be reduced without affecting network performance for applications on the STA 405. For example, the CUI 455 may CUI indicate that an improvement in utilization associated with communicating using all of the secondary channels in the operating bandwidth is below a threshold. In some examples, the reduced operating bandwidth excludes at least one secondary channel from the operating bandwidth and reduces power and device resource consumptions at the STA 405 and the AP 410. Additional examples of an operating bandwidth reduction are described in more detail with reference to FIGS. 5, 6A, 6B and 7.

In some implementations the STA 405 may also implement a temporary or optional primary channel in the communication link 440 according to a NPCA scheme. For example, the CUI 455 may indicate that a secondary channel is associated with higher network performance than the primary channel. In some examples, the STA 405 communicates with the AP 410 using the higher performing secondary channels as the optional primary channel in accordance with the NPCA scheme and in accordance with the CUI. In some examples, the STA 405 may also transmit an indication of the optional primary channel to the AP 410. For example, the STA 405 may transmit an optional primary channel frame 445 to the AP 410 indicating the usages of the selected secondary channel as the optional primary channel. In some examples, the optional primary channel frame is UHR or Wi-Fi 8 variant trigger or control frame. Additional examples of using a secondary channel as an optional primary channel are described in more detail with reference to FIGS. 5, 6A, 6B and 8.

FIG. 5 shows a pictorial diagram of a frequency band 500 with operating bandwidths. In some examples, the frequency band 500 includes multiple sub-bands and multiple frequency channels such as frequency channels 505. In some examples, each of the individual channels in the frequency channels 505 has a uniform channel width, such as channel width 507. In some examples, the channel width 507 may be any of 20 MHz, 40 MHz, or 80 MHz, among other examples. In the examples described herein, the channel width 507 is 20 MHz for the frequency channels 505. In some examples, network devices are capable of transmitting at higher bandwidths using a bonded wireless channel or operating bandwidth that is made up of multiple channels. For example, the STA 405 and the AP 410, described herein with reference to FIG. 4, may support ultra-high reliability (UHR) communications or communication according to the IEEE 802.11bn including bonded channels or operating bandwidth that combines multiple of the frequency channels 505. For example, operating BW 510 includes various subchannels such as the frequency channels Ch1 505a and Ch2 505b of the frequency channels 505. In some examples, the operating BW 510 combines/bonds the channel widths (20 Mhz) of Ch1 505a and Ch1 505b for a 40 MHz channel bandwidth. Additional operating bandwidths with varying channel bandwidths may also be used. For example, operating BW 520 includes Ch1 505a-Ch4 505d to form an 80 MHz channel bandwidth. The operating BW 530 includes Ch1 505a-Ch 8 505h for form a 160 MHz channel bandwidth. The operating BW 540 includes Ch1 505a-Ch 16 505p for form a 320 MHz channel bandwidth. In some examples, operating bandwidths larger than a 320 MHz channel bandwidth, such as 480 MHz, 640 MHz or greater, may also be formed. In some examples, a channel within the operating bandwidth may be designated by the AP 410 or other network device, as a primary channel for network communications in the respective operating bandwidth. The AP 410 and other network devices may provide channel utilization information for the selected primary channel by default, but client devices, STAs, including the STA 405, and other network device devices may optimize various decision-making actions when provided detailed channel utilization metrics and information for all bonded channels in an operating bandwidth as described with reference to FIGS. 6A-10.

FIG. 6A shows an example quality of service basic service set (QBSS) load element 600 usable for providing channel utilization information for primary and secondary channels to network devices. For example, the 410 may provide the CUI 455 to the STA 405, described with reference to FIG. 4, as or as part of the QBSS load element 600. In some examples, a QBSS load element may only report channel utilization and other information a for primary channel in a given operating bandwidth which provides an incomplete picture of overall network load of an operating bandwidth. The QBSS load element 600 includes fields which provide CUI for a primary channel and the secondary channel of an operating bandwidth, where the receiving client device/STA uses the CUI to improve device and network performance.

In some examples, the QBSS load element 600 may be provided as or as part of the PDU 200 or PPDU 350 described with reference to FIGS. 2 and 3. In some examples, the QBSS load element 600 may be included in a beacon frame or a probe response frame as described with reference to FIG. 4. In some examples, the QBSS load element 600 includes fields to ensure compatibility with legacy devices. For example, the QBSS load element 600 includes a legacy field 610 which is interpretable by legacy devices, including legacy wireless STAs. In some examples, the QBSS load element 600 also includes extended fields 620 that are interpretable by non-legacy devices, including non-legacy wireless STAs and not by the legacy wireless STAs. In some examples, the legacy fields 610 include CUI for the primary channel in an operating bandwidth and the extended fields 620 include or contain the CUI for the one or more secondary channels. The extended fields 620 may also include/contain an aggregate CUI for the operating bandwidth.

In some implementations, the legacy fields 610 include several fields including element ID 611, length 612, STA count 613, primary CUI 614 and available admission capacity 615. In some examples, the element ID 611 identifies the legacy fields 610 as a standard QBSS Load Element and the length 612 specifies the length of the QBSS Load Element or the legacy fields 610. In some examples, the STA count 613 identifies the number of stations currently associated with the BSS at the AP and the available admission capacity 615 includes the remaining bandwidth for QoS traffic. The primary CUI 614 reports channel utilization for a primary 20 MHz channel of a bonded group or operating bandwidth. With reference to FIG. 5, the operating BWs 510-540 may each have the Ch1 505a designated as the primary channel for the respective operating bandwidth. While Ch1 505a is designated herein as the primary channel for illustration and description purposes, any channel in each operating bandwidth may be selected as the primary channel in the operating bandwidth. In some examples, the primary CUI 614 includes the channel utilization of the Ch1 505a. In some examples, a receiving legacy STA may receive the QBSS load element 600 and only interpret and utilize the legacy fields 610, including the primary CUI 614 and ignore the remaining information the extended fields 620.

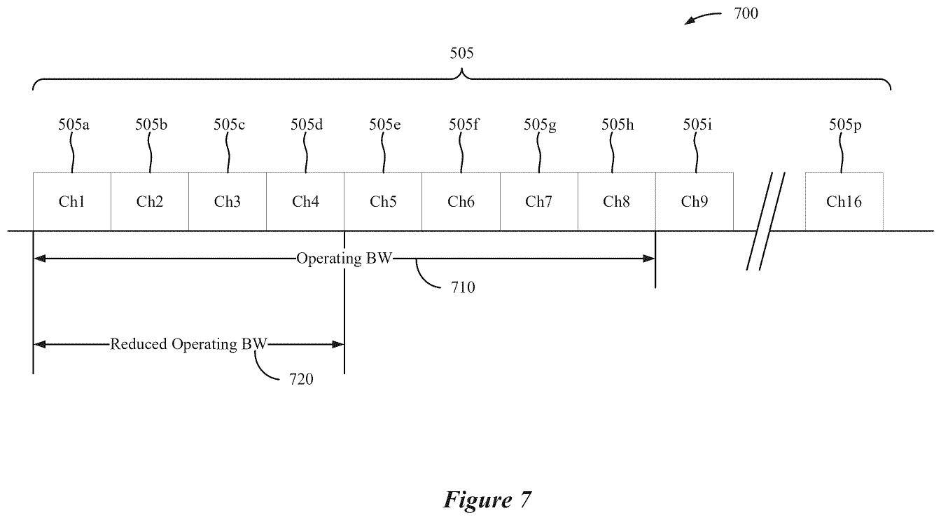

In some implementations, the extended fields 620 include an extended element ID 625 and extended length 630. In some examples, the extended element ID 625 is a 1 byte field and identifies the QBSS load element 600 and the extended fields 620 as containing additional CIU or is an extended QBSS Load Element. In some examples, the extended length 630 is a 1 byte field and specifies the length of the extended fields 620 or the UHR extended QBSS load element. In some examples, the extended length 630 is a 1 byte field and indicates whether there is information in the remaining fields based on the size of an associated operating bandwidth. In some examples, secondary CUIs (S-CUIs) 635, 640, 645, and 650 includes CUI for the operating bandwidth and utilization is based on the size of the operating bandwidth. For example, the S-CUI 635 is a 1 byte field for a 40 MHz channel bandwidth, such as the operating BW 510, and contains CUI for a second 20 MHz subchannel, such as the Ch2 505b. In some examples, the S-CUI 640 is a 2 byte field for an 80 MHz channel bandwidth, such as the operating BW 520, and contains CUI for a third 20 MHz subchannel, such as the Ch3 505c and a fourth 20 MHz subchannel, such as the Ch4 505d. In some examples, the S-CUI 645 is a 4 byte field for a 160 MHz channel bandwidth, such as the operating BW 530, and contains CUI for a fifth 20 MHz subchannel, such as Ch5 505e, a sixth 20 MHz subchannel, such as Ch6 505f, a seventh 20 MHz subchannel, such as Ch7 505g and an eighth 20 MHz subchannel, such as Ch8 505h. In some examples, the S-CUI 650 is an 8 byte field for a 320 MHz channel bandwidth, such as the operating BW 540, and contains CUI for a ninth 20 MHz subchannel, such as the Ch9 505i, a tenth 20 MHz subchannel, such as the Ch10 505j, an eleventh 20 MHz subchannel, such as the Ch11 505k, a twelfth 20 MHz subchannel, such as the Ch12 505l, a thirteenth 20 MHz subchannel, such as the Ch13 505m, a fourteenth 20 MHz subchannel, such as the Ch14 505n, a fifteenth 20 MHz subchannel, such as the Ch15 505o, and a sixteenth 20 MHz subchannel, such as the Ch16 505p. In some examples, the extended fields 620 and the S-CUIs, in particular, provide granular or detailed metrics for each bonded subchannel, which provide for more accurate network connection related decisions by STAs, including STA 405. For example, STA 405 may select a secondary channel and an optional primary channel may use the granular information in the extended fields to select an optimal secondary channel using the CUI based on actual channel load which improves performance for at least latency-sensitive applications on the STA 4-5 as described in more detail herein with reference to FIGS. 7-11.

In some examples, aggregate CUI 655 is a 1 byte field that contains aggregate CUI for the operating bandwidth. For example, the aggregate CUI may include a weighted or average utilization across the entire bonded channel set or operating bandwidth. In some examples, the aggregate CUI may be used by a STA as a quick reference for network congestion. For example, STA 405 may use the aggregate CUI as a quick snapshot of network load and reduce the complexity of AP association and operating bandwidth reduction decisions in environments with many bonded channels as described in more detail herein with reference to FIGS. 7-11.

FIG. 6B shows an example quality of service basic service set (QBSS) load element 660 usable for providing channel utilization information for primary and secondary channels to network devices. For example, the 410 may provide the CUI 455 to the STA 405, described with reference to FIG. 4, as or as part of the QBSS load element 660. In some examples, the QBSS load element 660 includes fields which provide CUI for a primary channel and the secondary channel of an operating bandwidth, where the receiving client device/STA uses the CUI to improve device and network performance.

In some examples, the QBSS load element 660 may be provided as or as part of the PDU 200 or PPDU 350 described with reference to FIGS. 2 and 3. In some examples, the QBSS load element 660 may be included in a beacon frame or a probe response frame as described with reference to FIG. 4. In some examples, the QBSS load element 660 is a newly defined load element for use with devices that provide for operating bandwidths. For example, the QBSS load element 660 includes extended fields 670 which may not be interpretable by legacy devices, such as the legacy wireless STAs. In some examples, the extended fields 670 include CUI for the primary channel in an operating bandwidth, the CUI for the one or more secondary channels, and the aggregate CUI for the operating bandwidth.

In some implementations, the extended fields 670 include information fields including includes an extended element ID 671 and extended length 672, and primary CUI 675. In some examples, the extended element ID 671 identifies the extended fields 670 and the QBSS load element 660 as an extended QBSS Load Element and the extended length 672 specifies the length of the extended QBSS Load Element or the extended fields 670. In some examples, the primary CUI 675 reports channel utilization for a primary 20 MHz channel of a bonded group or operating bandwidth. For example, with reference to FIG. 5, the operating BWs 510-540 may each have the Ch1 505a designated as the primary channel for the respective operating bandwidth. In some examples, the primary CUI 675 includes the channel utilization of the Ch1 505a.

In some examples, S-CUIs 680, 681, 682, and 683 includes CUI for the operating bandwidth and utilization is based on the size of the operating bandwidth. For example, the S-CUI 680 is a 1 byte field for a 40 MHz channel bandwidth, such as the operating BW 510, and contains CUI for a second 20 MHz subchannel, such as the Ch2 505b. In some examples, the S-CUI 681 is a 2 byte field for an 80 MHz channel bandwidth, such as the operating BW 520, and contains CUI for a third 20 MHz subchannel, such as the Ch3 505c and a fourth 20 MHz subchannel, such as the Ch4 505d. In some examples, the S-CUI 682 is a 4 byte field for a 160 MHz channel bandwidth, such as the operating BW 530, and contains CUI for a fifth 20 MHz subchannel, such as Ch5 505e, a sixth 20 MHz subchannel, such as Ch6 505f, a seventh 20 MHz subchannel, such as Ch7 505g and an eighth 20 MHz subchannel, such as Ch8 505h. In some examples, the S-CUI 683 is an 8 byte field for a 320 MHz channel bandwidth, such as the operating BW 540, and contains CUI for a ninth 20 MHz subchannel, such as the Ch9 505i, a tenth 20 MHz subchannel, such as the Ch10 505j, an eleventh 20 MHz subchannel, such as the Ch11 505k, a twelfth 20 MHz subchannel, such as the Ch12 505l, a thirteenth 20 MHz subchannel, such as the Ch13 505m, a fourteenth 20 MHz subchannel, such as the Ch14 505n, a fifteenth 20 MHz subchannel, such as the Ch15 505o, and a sixteenth 20 MHz subchannel, such as the Ch16 505p. In some examples, the extended fields 670 and the S-CUIs, in particular, provide granular or detailed metrics for each bonded subchannel, which provide for more accurate network connection related decisions by STA 405. For example, STA 405 may select a secondary channel and an optional primary channel may use the granular information in the extended fields 670 to select an optimal secondary channel using the CUI based on actual channel load which improves performance for at least latency-sensitive applications on the STA 405 as described in more detail herein with reference to FIGS. 7-11.

In some examples, aggregate CUI 690 is a 1 byte field that contains aggregate CUI for the operating bandwidth. For example, the aggregate CUI may include a weighted or average utilization across the entire bonded channel set or operating bandwidth. In some examples, the aggregate CUI may be used by a STA as a quick reference for network congestion. For example, STA 405 may use the aggregate CUI as a quick snapshot of network load and reduce the complexity of AP association and operating bandwidth reduction decisions in environments with many bonded channels as described in more detail herein with reference to FIGS. 7-11.

FIG. 7 shows a pictorial diagram of a frequency band 700 with a reduced operating bandwidth. In some examples, the frequency band 700 is similar to the frequency band 500 described with reference to FIG. 5 and includes the frequency channels 505. In some examples, the AP 410 and the STA 405 may establish or operate the communication link 440 using a designated operating BW 710. For example, the AP 410 may designate the designated operating BW 710 as the operating BW for the communication link 440 during a connection establishment process. In some examples, the designated operating BW 710 may include any of the operating BWs 510, 520, 530 and 540. In the example shown in FIG. 7 the designated operating BW 710 has a channel width of 160 Mhz. For example, the designated operating BW is the operating BW 530 described with reference to FIG. 5 and includes the channels Ch1 505a-Ch 8 505 h to form the 160 MHz channel.

In some examples, the STA 405 receives CUI 455 in the form of the QBSS load element 600 which includes S-CUI 635, 640 and 645 and the related CUI for each of the secondary channels Ch2 505b-Ch8 505h and the aggregate CUI 655 containing aggregate CUI for the operating bandwidth. In some examples, the STA 405 may examine each of the secondary CUI and the aggregate CUI and determine whether operating the full designated operating BW 710 provides an increase in network performance. For example, the CUI may indicate that an improvement in utilization, congestion or other similar network performance metrics associated with communicating using all of the one or more secondary channels in the operating bandwidth is below a threshold.

For example, the channels in the operating BW may not be overly congested or the STA 405 may not be operating a latency sensitive application, such that the STA 405 may operate on a smaller operating BW than the designated operating BW 710. For example, the STA 405 may determine, using the threshold, that a same or similar level of QoS and network connectivity may be accomplished by a reduced operating BW 720. In some examples, the reduced operating BW 720 excludes at least one of the one or more secondary channels. For example, the reduced operating BW is an 80 MHz channel bandwidth, such as the operating BW 520. In some examples, the STA 405 begins communicating with the AP 410 using the reduced operating BW 720 which reduces device power and network resource consumption. While described above in relation to a 160 Mhz and 80 Mhz channel bandwidth, any of the operating BW 510-540 may be reduced using reduced operating bandwidth processes described above.

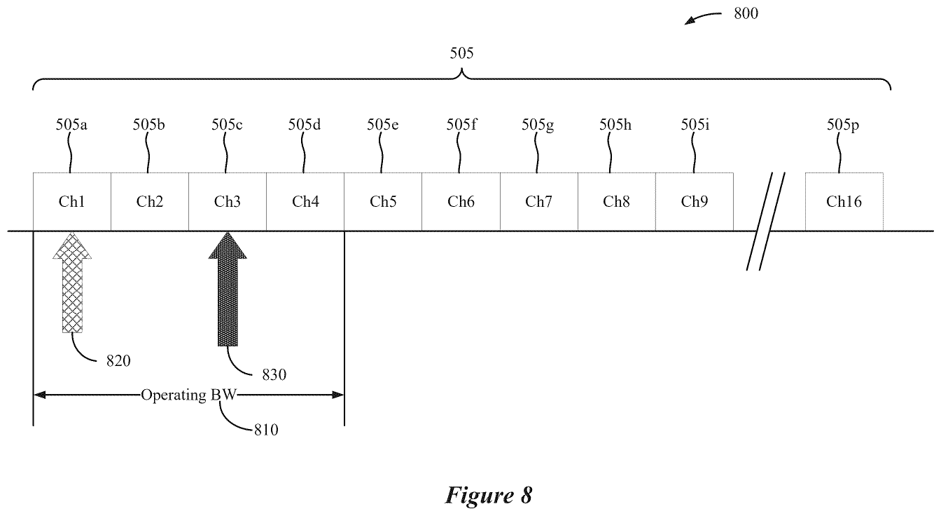

FIG. 8 shows a pictorial diagram of a frequency band 800 with an optional primary channel. In some examples, the frequency band 800 is similar to the frequency band 500 described with reference to FIG. 5 and includes the frequency channels 505. In some examples, the AP 410 and the STA 405, described with reference to FIG. 4, may establish or operate the communication link 440 using an operating BW 810. In some examples, the operating BW 810 has 80 MHz channel bandwidth, such as the operating BW 520 In some examples, the operating BW 810 includes a primary channel 820 where the primary channel typically handles network communication in the communication link 440.

In some implementations a client device or STA, such as the STA 405, implements a temporary or optional primary channel in a communication link, such as the communication link 440 according to an NPCA scheme. For example, the CUI 455 may indicate that a secondary channel, such as the Ch3 505c is associated with higher network performance than the primary channel. In some examples, the STA 405 communicates with the AP 410 using the higher performing secondary channel Ch3 505c as optional primary channel 830 in accordance with the NPCA scheme and in accordance with the CUI. In some examples, the STA 405 may also transmit an indication of the optional primary channel to the AP 410. For example, the STA 405 may transmit an optional primary channel frame 445 to the AP 410 to indicate the utilization of the Ch 3 505c as the optional primary channel 830. In some examples, the optional primary channel frame is UHR or Wi-Fi 8 variant trigger or control frame that includes the indication of the Ch 3 505c as the optional primary channel 830.

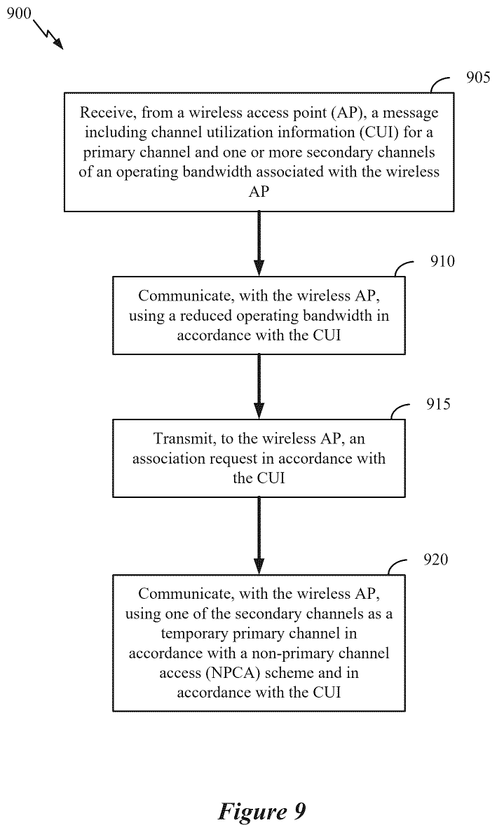

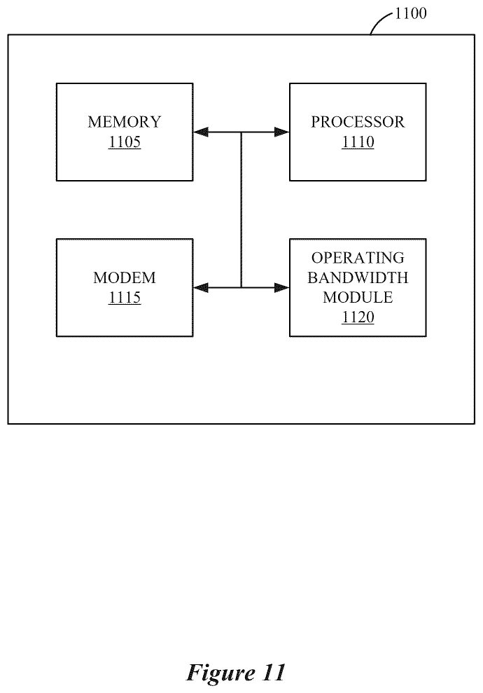

FIG. 9 shows a flowchart illustrating an example process 900 performable by or at a wireless station (STA) that supports providing CUI for each primary and secondary channel in an operating bandwidth to improve wireless communication device operation and wireless communication network performance. The operations of the process 900 may be implemented by a wireless STA or its components as described herein. For example, the process 900 may be performed by a wireless communication device, such as the wireless communication device 1100 described with reference to FIG. 11, operating as or within a wireless STA. In some examples, the process 900 may be performed by a wireless STA such as one of the STAs 104 described with reference to FIG. 1 and the STA 405 described with reference to FIG. 4.

In some examples, at block 905, the wireless STA receives, from a wireless AP, a message including CUI for a primary channel and one or more secondary channels of an operating bandwidth associated with the wireless AP. For example, with reference to FIG. 4, the AP 410 in the WLAN 415 provides or reports utilization metrics for each bonded 20 MHz sub-channel in a message to the STA 405 in the WLAN 415. For example, the AP 410 provides the message 450, including the CUI 455, to the STA 405. In some examples, the message 450 is or is included in a beacon frame or a probe response frame sent from the AP 410. For example, the AP 410 may periodically transmit or broadcast a beacon frame including the CUI 455 or may send the message 450 as a probe response frame in response to a probe frame, such as the probe request frame 430. In some examples, the STA 405 receives the message 450 and the CUI 455 and uses detailed or granular information provided by the CUI 455 to select and perform one or more of the various STA actions shown in blocks 910, 915 and 920.

In some examples, the message is or includes a QBSS load element such as the QBSS load element 600 described with reference to FIG. 6A or the QBSS load element 660 described with reference to FIG. 6A. In some examples, the QBSS load element includes a backward compatible format including a first field interpretable by legacy wireless STAs that contains the CUI for the primary channel, such the primary CUI 614. In some examples, the QBSS load element 600 also includes one or more second fields interpretable by non-legacy wireless STAs, such as the S-CUIs 635, 640 and 645. In some examples, the QBSS load element 600 also includes a third field interpretable by non-legacy wireless STAs, such as the aggregate CUI 655 that contains aggregate CUI for the operating bandwidth. In some examples, aggregate CUI 655 or aggregate CUI 690 is a 1 byte field that contains aggregate CUI for the operating bandwidth. For example, the aggregate CUI may include a weighted or average utilization across the entire bonded channel set or operating bandwidth. In some examples, the aggregate CUI may be used by a STA as a quick reference for network congestion. For example, STA 405 may use the aggregate CUI as a quick snapshot of network load and reduce the complexity of AP association and operating bandwidth reduction decisions in environments with many bonded channels or operating bandwidths.

In some examples, the CUI 455, including the extended fields 620 and 670 and the S-CUIs, in particular, provide granular or detailed metrics for each bonded sub-channel in an operating bandwidth. For example, the one or more second fields, such as the S-CUIs 635, 640 and 645 and the S-CUIs 680, 681, 682 and 683, include a respective field for a 40 MHz channel bandwidth of the operating bandwidth, such as the operating BW 510, an 80 MHz channel bandwidth of the operating bandwidth, such as the operating BW 520, a 160 MHz channel bandwidth of the operating bandwidth, such as the operating BW 530, and a 320 MHz channel bandwidth of the operating bandwidth, such as the operating BW 540.

In some examples, the primary channel is a first 20 MHz subchannel and the CUI for the primary channel is located in the first legacy field, such the primary CUI 614 or is located in primary CUI 675 in the QBSS load element 660. In some examples, the field for the 40 MHz channel bandwidth contains CUI for a second 20 MHz subchannel. For example, the S-CUI 635 (or the S-CUI 680) is a 1 byte field for the 40 MHz channel bandwidth, such as the operating BW 510, and contains CUI for a second 20 MHz subchannel, such as the Ch2 505b.

In some examples, the field for the 80 MHz channel bandwidth contains CUI for a third 20 MHz subchannel and a fourth 20 MHz subchannel. For example, the S-CUI 640 (or the S-CUI 681) is a 2 byte field for the 80 MHz channel bandwidth, such as the operating BW 520, and contains CUI for a third 20 MHz subchannel, such as the Ch3 505c and a fourth 20 MHz subchannel, such as the Ch4 505d.

In some examples, the field for the 160 MHz channel bandwidth contains CUI for a fifth 20 MHz subchannel, a sixth 20 MHz subchannel, a seventh 20 MHz subchannel and an eighth 20 MHz subchannel. For example, the S-CUI 645 (or the S-CUI 682) is a 4 byte field for the 160 MHz channel bandwidth, such as the operating BW 530, and contains CUI for a fifth 20 MHz subchannel, such as Ch5 505e, a sixth 20 MHz subchannel, such as Ch6 505f, a seventh 20 MHz subchannel, such as Ch7 505g and an eighth 20 MHz subchannel, such as Ch8 505h.

In some examples, the field for the 320 MHz channel bandwidth contains CUI for a ninth 20 MHz subchannel, a tenth 20 MHz subchannel, an eleventh 20 MHz subchannel, a twelfth 20 MHz subchannel, a thirteenth 20 MHz subchannel, a fourteenth 20 MHz subchannel, a fifteenth 20 MHz subchannel, and a sixteenth 20 MHz subchannel. For example, the S-CUI 650 (or the S-CUI 683) is an 8 byte field for the 320 MHz channel bandwidth, such as the operating BW 540, and contains CUI for a ninth 20 MHz subchannel, such as the Ch9 505i, a tenth 20 MHz subchannel, such as the Ch10 505j, an eleventh 20 MHz subchannel, such as the Ch11 505k, a twelfth 20 MHz subchannel, such as the Ch12 505l, a thirteenth 20 MHz subchannel, such as the Ch13 505m, a fourteenth 20 MHz subchannel, such as the Ch14 505n, a fifteenth 20 MHz subchannel, such as the Ch15 505o, and a sixteenth 20 MHz subchannel, such as the Ch16 505p.

In some examples, the granular or detailed metrics provide for more accurate network connection related decisions by STA 405. For example, the STA 405 utilizes the CUI 455 to select and perform the various STA actions shown in shown in blocks 910, 915 and 920. While shown as blocks in FIG. 9, the process 900 may include only one of the blocks 910-920 or any combination of two or three of the blocks 910-920.

In some examples, at block 910, the wireless STA transmits, to the wireless AP, an association request in accordance with the CUI. In some examples, transmitting the association request in accordance with the CUI includes transmitting the association request in accordance with the CUI satisfying a threshold or in accordance with a metric associated with the CUI being greater than a second metric associated with second CUI received from a second wireless AP. For example, with reference to FIG. 4, the STA 405 communicates with the AP 410 and the AP 460 prior to establishing a link or associating with a given AP in the WLAN 415. For example, the STA 405 may send or transmit a probe request frame 430 to the AP 410, where the AP 410 sends the message 450 as a probe response frame with the CUI 455. In some examples, the STA 405 evaluates the CUI to determine whether a connection or communication link to the AP 410 would provide a sufficient network connection for the expected network connection performance at the STA 405.

For example the STA 405 may determine whether a communication link to the AP with an operating bandwidth would satisfy a threshold for a network performance metric(s) such as throughput, QoS, congestion, reliability or other similar network performance metrics. In some examples, the STA 405 may also evaluate the CUI and the network performance metric(s) associated with the CUI 455 as compared to a second network performance metric(s) associated with CUI 465 received from the AP 460. In some examples, the STA 405 may determine that CUI 455 indicates the threshold for the network performance metrics are met or provides for better network performance than the CUI 465 and sends/transmits an association request 435 in accordance with the CUI 455 to the AP 410 to establish a communication link 440 with an operating bandwidth.

In some examples, at block 915, the wireless STA communicates, with the wireless AP, using a reduced operating bandwidth in accordance with the CUI. In some examples, the reduced operating bandwidth excludes at least one of the one or more secondary channels. In some examples, communicating, with the wireless AP, using the reduced operating bandwidth in accordance with the CUI includes communicating using the reduced operating bandwidth in accordance with the CUI for the primary channel, the CUI for the one or more secondary channels, and an aggregate CUI indicating that an improvement in utilization associated with communicating using all of the one or more secondary channels in the operating bandwidth is below a threshold.

For example, with reference to FIGS. 4 and 7, the STA 405 may evaluate whether updates to the communication link 440 may improve device performance or resource conservation. For example, the STA 405 may update the communication link 440 in order to communicate with the AP 410 using a reduced operating bandwidth in accordance with the CUI. For example, the STA 405 may determine from the CUI 455 that the operating bandwidth may be reduced without affecting network performance for applications on the STA 405.

For example, the AP 410 and the STA 405 may establish or operate the communication link 440 using a designated operating BW 710. In some examples, the AP 410 may designate the designated operating BW 710 as the operating BW for the communication link 440 during a connection establishment process. The designated operating BW 710 may include any of the operating BWs 510, 520, 530 and 540 or other operating bandwidths not shown in FIG. 7. In the example shown in FIG. 7 the designated operating BW 710 has a 160 Mhz. For example, the designated operating BW is the operating BW 530 described with reference to FIG. 5 and includes the channels Ch1 505a-Ch 8 505h to form the 160 MHz channel bandwidth.

In some examples, the STA 405 receives the CUI 455 in the form of the QBSS load element 600 which includes S-CUI 635, 640 and 645 or the QBSS load element 660 which includes S-CUI 681, 682 and 683 and the related CUI for each of the secondary channels Ch2 505b-Ch8 505h and the aggregate CUI for the operating bandwidth. In some examples, the STA 405 may examine each of the secondary CUI and the aggregate CUI and determine whether operating the full designated operating BW 710 provides an increase in network performance. For example, the CUI may indicate that an improvement in utilization associated with communicating using all of the one or more secondary channels in the operating bandwidth is below a threshold.

For example, the channels in the operating BW may not be overly congested such that the STA 405 may operate on a smaller operating BW than the designated operating BW 710. For example, the STA 405 may determine, using the threshold, that a same or similar level of QoS and network connectivity may be accomplished by a reduced operating BW 720. For example, the reduced operating BW is an 80 MHz channel bandwidth, such as the operating BW 520. In some examples, the STA 405 begins communicating with the AP 410 using the reduced operating BW 720 which reduces device power and network resource consumption.

In some examples, at block 920, the wireless STA communicates, with the wireless AP, using one of the secondary channels as a temporary primary channel in accordance with an NPCA scheme and in accordance with the CUI. In some examples, the optional primary channel is a secondary channel of the one or more secondary channels. In some examples, communicating using one of the secondary channels as the optional primary channel in accordance with the NPCA scheme and in accordance with the CUI includes communicating, with the wireless AP, using the secondary channel in accordance with the CUI for the primary channel and the CUI for the one or more secondary channel indicating that the secondary channel is associated with higher network performance than the primary channel.

For example, with reference to FIGS. 4 and 8 the STA 405 may implement a temporary or optional primary channel in the communication link 440 according to the NPCA scheme. For example, the CUI 455 may indicate that a secondary channel is associated with higher network performance than the primary channel. For example, the AP 410 and the STA 405 may establish or operate the communication link 440 using the operating BW 810 which includes the primary channel 820, which handles network communication in the communication link 440. In some examples, the CUI 455 may indicate that a secondary channel, such as the Ch3 505c, is associated with higher network performance than the primary channel. In some examples, the STA 405 selects to communicate with the AP 410 using the higher performing secondary channel Ch3 505c as the optional primary channel 830 in accordance with the NPCA scheme and in accordance with the CUI.

In some examples, the STA 405 may also transmit an indication of the optional primary channel to the AP 410. For example, the STA 405 may transmit an optional primary channel frame 445 to the AP 410 to indicate the utilization of the Ch 3 505c as the optional primary channel. In some examples, the optional primary channel frame is UHR or Wi-Fi 8 variant trigger or control frame that includes the indication of the Ch 3 505c as the optional primary channel.

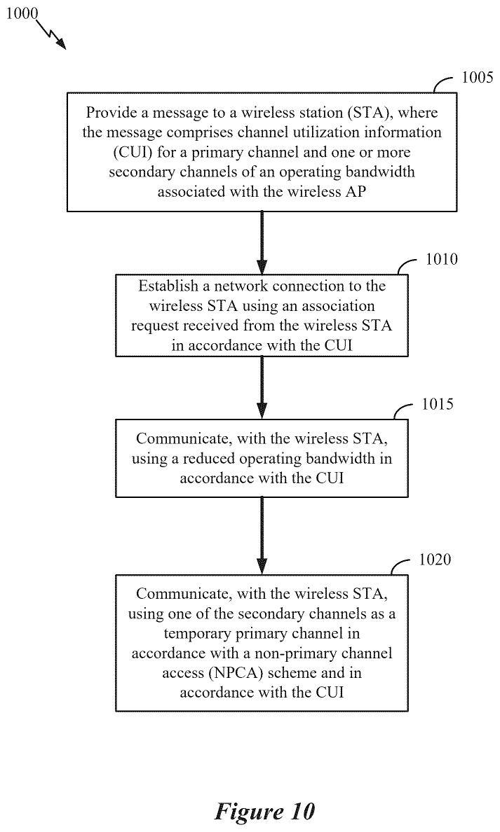

FIG. 10 shows a flowchart illustrating an example process 1000 performable by or at a wireless access point (AP) that supports providing CUI for each primary and secondary channel in an operating bandwidth to improve wireless communication device operation and wireless communication network performance. The operations of the process 1000 may be implemented by a wireless AP or its components as described herein. For example, the process 1000 may be performed by a wireless communication device, such as the wireless communication device 1100 described with reference to FIG. 11, operating as or within a wireless AP. In some examples, the process 1000 may be performed by a wireless AP such as one of the APs 102 described with reference to FIG. 1 and the AP 410 described with reference to FIG. 4.

In some examples, at block 1005, the wireless AP provides a message to a wireless station (STA), where the message includes CUI for a primary channel and one or more secondary channels of an operating bandwidth associated with the wireless AP. In some examples, with reference to FIG. 4, the AP 410 and the AP 460 collect or compile CUI for each frequency channel in an operating frequency band associated with the WLAN 415. In some examples, the AP 410 may operate in one or more frequency bands such as the 2.4 GHz, 5 GHz, 6 GHz, 45 GHz, or 60 GHz bands and collect CUI representing network activity and other information on each frequency channel of a given operating frequency. For example, the AP 410 and the STA 405 may both communicate and operate in at least one frequency band, such as frequency band 420, where the AP 410 monitors and collects CUI for each frequency channel in the frequency band 420. The AP 410 provides the collected CUI for the frequency band 420 or for an operating bandwidth subset to the STA 405 as the CUI 455. In some examples, the AP 460 also monitors and collects CUI for the frequency band 420 and provides CUI 465 to the STA 405 via a message similar to the message 450 or other similar means.

In some examples, the AP 410 provides or reports utilization metrics for each bonded 20 MHz sub-channel in the message 450. In some examples, the message 450 is or is included in a beacon frame or a probe response frame sent from the AP 410. For example, the AP 410 may periodically transmit or broadcast a beacon frame including the CUI 455 or may send the message 450 as a probe response frame in response to a probe frame, such as the probe request frame 430. In some examples, the STA 405 receives the message 450 and the CUI 455 and uses detailed or granular information provided by the CUI 455 to select and perform one or more of the various STA actions shown in blocks 910, 915 and 920 described herein with reference to FIG. 9.

In some examples, the message is or includes a QBSS load element such as the QBSS load element 600 described in relation to FIG. 6A or the QBSS load element 660 described in relation to FIG. 6B. In some examples, the QBSS load element includes a first field interpretable by legacy wireless STAs that contains the CUI for the primary channel, such the primary CUI 614. In some examples, the QBSS load element 600 also includes one or more second fields interpretable by non-legacy wireless STAs, such as the S-CUIs 635, 640 and 645. In some examples, the QBSS load element 600 also includes a third field interpretable by non-legacy wireless STAs, such as the aggregate CUI 655 that contains aggregate CUI for the operating bandwidth. In some examples, aggregate CUI 655 is a 1 byte field that contains aggregate CUI for the operating bandwidth. For example, the aggregate CUI may include a weighted or average utilization across the entire bonded channel set or operating bandwidth. In some examples, the aggregate CUI may provide a receiving device with a quick reference for network congestion observed by the wireless AP.

In some examples, the CUI 455, including the extended fields 620 or the extended fields 670 and the S-CUIs, in particular, provide granular or detailed metrics for each bonded sub-channel in an operating bandwidth

In some examples, the granular or detailed metrics provide for more accurate network connection related decisions by devices that receive the CUI, including STAs such as the STA 405. For example, the STA 405 utilizes the CUI 455 to select and perform the various STA actions shown in shown in blocks 910, 915 and 920. In some examples, the wireless AP, including the AP 410, perform actions shown in blocks 1010, 1015 and 1020, based on the decisions made by the receiving device, such as the STA 405. While shown as blocks in FIG. 10, the process 1000 may include only one of the blocks 1010, 1015 and 1020 or any combination of two or three of the blocks 1010, 1015 and 1020.

In some examples, at block 1010, the wireless AP establishes a network connection to the wireless STA using an association request received from the wireless STA in accordance with the CUI. For example, with reference to FIG. 4, the STA 405 may communicate with the AP 410 and the AP 460 prior to establishing a communicating link or otherwise associating with a given AP in the WLAN 415. For example, the STA 405 may send or transmit a probe request frame 430 to the AP 410, where the AP 410 sends the message 450 as a probe response frame with the CUI 455. In some examples, the STA 405 evaluates the CUI to determine whether a connection or communication link to the AP 410 would provide a sufficient network connection for the expected network connection performance at the STA 405. In some examples, the association request is received from the wireless STA in accordance with the CUI indicates the CUI satisfies a threshold at the wireless STA or the CUI satisfies a metric associated with the CUI being greater than a second metric associated with a second CUI received at the wireless STA from a second wireless AP. For example, the STA 405 may send or transmit a probe request frame 430 to the AP 410, where the AP 410 sends the message 450 as a probe response frame with the CUI 455. In some examples, the STA 405 evaluates the CUI to determine whether a connection or communication link to the AP 410 would provide a sufficient network connection for the expected network connection performance at the STA 405.

For example the STA 405 may determine whether a communication link to the AP with an operating bandwidth would satisfy a threshold for a network performance metric(s) such as throughput, QoS, congestion, reliability or other similar network performance metrics. In some examples, the STA 405 may also evaluate the CUI and the network performance metric(s) associated with the CUI 455 as compared to a second network performance metric(s) associated with CUI 465 received from the AP 460. In some examples, the STA 405 may determine that CUI 455 indicates the threshold for the network performance metrics are met or provides for better network performance than the CUI 465 and the AP 410 receives the association request 435 in accordance with the CUI 455 and establishes the communication link 440 with an operating bandwidth.

In some examples, at block 1015, the wireless AP communicates, with the wireless STA, using a reduced operating bandwidth in accordance with the CUI. In some examples, the reduced operating bandwidth excludes at least one of the one or more secondary channels. In some examples, communicating, with the wireless STA, using the reduced operating bandwidth in accordance with the CUI includes communicating using the reduced operating bandwidth in accordance with the CUI for the primary channel, the CUI for the one or more secondary channels, and an aggregate CUI indicating that an improvement in utilization associated with communicating using all of the one or more secondary channels in the operating bandwidth is below a threshold.

For example, with reference to FIGS. 4 and 7, the STA 405 may evaluate whether updates to the communication link 440 may improve device performance or resource conservation. For example, the STA 405 may request an update to the communication link 440 and the AP 410 reduces the operating bandwidth in accordance with the CUI and request received from the STA.

In some examples, at block 1020, the wireless AP communicates, with the wireless STA, using one of the secondary channels as an optional primary channel in accordance with a non-primary channel access (NPCA) scheme and in accordance with the CUI. In some examples, the optional primary channel is a secondary channel of the one or more secondary channels. In some examples, communicating using one of the secondary channels as the optional primary channel in accordance with the NPCA scheme and in accordance with the CUI includes communicating, with the wireless AP, using the secondary channel in accordance with the CUI for the primary channel and the CUI for the one or more secondary channel indicating that the secondary channel is associated with higher network performance than the primary channel.

For example, with reference to FIGS. 4 and 8 the STA 405 may implement a temporary or optional primary channel in the communication link 440 according to the NPCA scheme. For example, the CUI 455 may indicate that a secondary channel is associated with higher network performance than the primary channel. For example, the AP 410 and the STA 405 may establish or operate the communication link 440 using the operating BW 810 which includes the primary channel 820, which handles network communication in the communication link 440. In some examples, the CUI 455 may indicate that a secondary channel, such as the Ch3 505c, is associated with higher network performance than the primary channel. In some examples, the STA 405 selects to communicate with the AP 410 using the higher performing secondary channel Ch3 505c and transmits the optional primary channel frame 445 to the AP 410 to indicate the utilization of the Ch 3 505c as the optional primary channel. In some examples, the optional primary channel frame is UHR or Wi-Fi 8 variant trigger or control frame that includes the indication of the Ch 3 505c as the optional primary channel. In some examples, the AP 410 begins communicating with the STA 405 using the optional primary channel upon receiving the optional primary channel frame 445.

FIG. 11 shows a block diagram of an example wireless communication device 1100 that supports providing CUI for each primary and secondary channel in an operating bandwidth to improve wireless communication device operation and wireless communication network performance. In some examples, the wireless communication device 1100 is configured as a wireless STA to perform the process 900 described with reference to FIG. 9. In some examples, the wireless communication device 1100 is also configured as a wireless AP to perform the process 1000 described with reference to FIG. 10. The wireless communication device 1100 may include one or more chips, SoCs, chipsets, packages, components or devices that individually or collectively constitute or include a processing system. The processing system may interface with other components of the wireless communication device 1100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1100 may transmit the information output from the chip. In such an example, the second interface may refer to an interface between the processing system of the chip and a reception component, such that the device 1100 may receive information that is passed to the processing system. In some such examples, the first interface also may obtain information, such as from the transmission component, and the second interface also may output information, such as to the reception component.

The processing system of the wireless communication device 1100 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1100 can be configurable or configured for use in an AP, such as the AP 102 described with reference to FIG. 1 and the AP 410 and AP 460 described with reference to FIG. 4. In some examples, the wireless communication device 1100 can be configurable or configured for use in an STA, such as the STA 104 described with reference to FIG. 1 and the STA 405 described with reference to FIG. 4. In some other examples, the wireless communication device 1100 can be an AP or STA that includes such a processing system and other components including multiple antennas. The wireless communication device 1100 is capable of transmitting and receiving wireless communications in the form of, for example, wireless packets. For example, the wireless communication device 1100 can be configurable or configured to transmit and receive packets in the form of physical layer PPDUs and MPDUs conforming to one or more of the IEEE 802.11 family of wireless communication protocol standards. In some other examples, the wireless communication device 1100 can be configurable or configured to transmit and receive signals and communications conforming to one or more 3GPP specifications including those for 5G NR or 6G. In some examples, the wireless communication device 1100 also includes or can be coupled with one or more application processors which may be further coupled with one or more other memories. In some examples, the wireless communication device 1100 further includes at least one external network interface coupled with the processing system that enables communication with a core network or backhaul network that enables the wireless communication device 1100 to gain access to external networks including the Internet.

The wireless communication device 1100 includes a memory component 1105, a processor component 1110, a modem component 1115 and an operating bandwidth module component 1120. Portions of one or more of the components 1105, 1110, 1110 and 1120 may be implemented at least in part in hardware or firmware. For example, the operating bandwidth module component 1120 may be implemented at least in part by a processor or a modem. In some examples, portions of one or more of the components 1105, 1110, 1110 and 1120 may be implemented at least in part by a processor and software in the form of processor-executable code stored in a memory.

The operating bandwidth module component 1120, operating as a wireless STA, is configurable or configured to receive, from a wireless AP, a message including CUI for a primary channel and one or more secondary channels of an operating bandwidth associated with the wireless AP and perform one or more actions. The actions may include transmitting, to the wireless AP, an association request in accordance with the CUI, communicating, with the wireless AP, using a reduced operating bandwidth in accordance with the CUI, and communicating, with the wireless AP, using one of the secondary channels as an optional primary channel in accordance with a non-primary channel access (NPCA) scheme and in accordance with the CUI.

Implementation examples are described in the following numbered clauses:

Clause 1. A wireless station (STA), including: a processing system that includes processor circuitry and memory circuitry that stores code, the processing system configured to cause the wireless STA to: receive, from a wireless access point (AP), a message including channel utilization information (CUI) for a primary channel and one or more secondary channels of an operating bandwidth associated with the wireless AP; and perform one or more of: transmit, to the wireless AP, an association request in accordance with the CUI; communicate, with the wireless AP, using a reduced operating bandwidth in accordance with the CUI; and communicate, with the wireless AP, using one of the secondary channels as an optional primary channel in accordance with a non-primary channel access (NPCA) scheme and in accordance with the CUI.

Clause 2. The wireless STA of clause 1, where the message includes a quality of service basic service set (QBSS) load element that includes: a first field, interpretable by legacy wireless STAs, that contains the CUI for the primary channel; and one or more second fields, interpretable by non-legacy wireless STAs and not by the legacy wireless STAs, that contain the CUI for the one or more secondary channels.

Clause 3. The wireless STA of any of clauses 1 and 2, where the QBSS load element further includes a third field, interpretable by the non-legacy wireless STAs and not by the legacy wireless STAs, that contains aggregate CUI for the operating bandwidth.

Clause 4. The wireless STA of any of clauses 1, 2 and 3, where the one or more second fields include a respective field for each of: a 40 MHz channel bandwidth of the operating bandwidth; an 80 MHz channel bandwidth of the operating bandwidth; a 160 MHz channel bandwidth of the operating bandwidth; and a 320 MHz channel bandwidth of the operating bandwidth.

Clause 5. The wireless STA of any of clauses 1, 2, 3 and 4, where: the primary channel is a first 20 MHz subchannel; the field for the 40 MHz channel bandwidth contains CUI for a second 20 MHz subchannel; the field for the 80 MHz channel bandwidth contains CUI for a third 20 MHz subchannel and a fourth 20 MHz subchannel; the field for the 160 MHz channel bandwidth contains CUI for a fifth 20 MHz subchannel, a sixth 20 MHz subchannel, a seventh 20 MHz subchannel and an eighth 20 MHz subchannel; and the field for the 320 MHz channel bandwidth contains CUI for a ninth 20 MHz subchannel, a tenth 20 MHz subchannel, an eleventh 20 MHz subchannel, a twelfth 20 MHz subchannel, a thirteenth 20 MHz subchannel, a fourteenth 20 MHz subchannel, a fifteenth 20 MHz subchannel, and a sixteenth 20 MHz subchannel.

Clause 6. The wireless STA of any of clauses 1, 2, 3, 4 and 5, where the message is included in a beacon frame or a probe response frame.

Clause 7. The wireless STA of any of clauses 1, 2, 3, 4, 5 and 6, where the transmitting, to the wireless AP, the association request in accordance with the CUI includes transmitting, to the wireless AP, the association request in accordance with the CUI satisfying a threshold or in accordance with a metric associated with the CUI being greater than a second metric associated with second CUI received from a second wireless AP.

Clause 8. The wireless STA of any of clauses 1, 2, 3, 4, 5, 6 and 7, where: the reduced operating bandwidth excludes at least one of the one or more secondary channels; and the communicating, with the wireless AP, using the reduced operating bandwidth in accordance with the CUI includes communicating using the reduced operating bandwidth in accordance with the CUI for the primary channel, the CUI for the one or more secondary channels, and an aggregate CUI indicating that an improvement in utilization associated with communicating using all of the one or more secondary channels in the operating bandwidth is below a threshold.

Clause 9. The wireless STA of any of clauses 1, 2, 3, 4, 5, 6, 7 and 8, where: the optional primary channel includes a secondary channel of the one or more secondary channels, and the communicating, with the wireless AP, using one of the secondary channels as the optional primary channel in accordance with the NPCA scheme and in accordance with the CUI includes communicating, with the wireless AP, using the secondary channel in accordance with the CUI for the primary channel and the CUI for the one or more secondary channel indicating that the secondary channel is associated with higher network performance than the primary channel.

Clause 10. The wireless STA of any of clauses 1, 2, 3, 4, 5, 6, 7, 8 and 9, where communicating, with the wireless AP, using one of the secondary channels as the optional primary channel includes: transmitting, to the wireless AP, an indication of the optional primary channel.

Clause 11. A method for wireless communication by a wireless station (STA), including: receiving, from a wireless access point (AP), a message including channel utilization information (CUI) for a primary channel and one or more secondary channels of an operating bandwidth associated with the wireless AP; and performing one or more of: transmitting, to the wireless AP, an association request in accordance with the CUI; communicating, with the wireless AP, using a reduced operating bandwidth in accordance with the CUI; and communicating, with the wireless AP, using one of the secondary channels as an optional primary channel in accordance with a non-primary channel access (NPCA) scheme and in accordance with the CUI.

Clause 12. The method of clause 11, where the message includes a quality of service basic service set (QBSS) load element that includes: a first field, interpretable by legacy wireless STAs, that contains the CUI for the primary channel; and one or more second fields, interpretable by non-legacy wireless STAs and not by the legacy wireless STAs, that contain the CUI for the one or more secondary channels.

Clause 13. The method of any of clauses 11 and 12, where the QBSS load element further includes a third field, interpretable by the non-legacy wireless STAs and not by the legacy wireless STAs, that contains aggregate CUI for the operating bandwidth.

Clause 14. The method of any of clauses 11, 12, and 13, where the one or more second fields include a respective field for each of: a 40 MHz channel bandwidth of the operating bandwidth; an 80 MHz channel bandwidth of the operating bandwidth; a 160 MHz channel bandwidth of the operating bandwidth; and a 320 MHz channel bandwidth of the operating bandwidth.

Clause 15. The method of any of clauses 11, 12, 13 and 14, where: the primary channel is a first 20 MHz subchannel; the field for the 40 MHz channel bandwidth contains CUI for a second 20 MHz subchannel; the field for the 80 MHz channel bandwidth contains CUI for a third 20 MHz subchannel and a fourth 20 MHz subchannel; the field for the 160 MHz channel bandwidth contains CUI for a fifth 20 MHz subchannel, a sixth 20 MHz subchannel, a seventh 20 MHz subchannel and an eighth 20 MHz subchannel; and the field for the 320 MHz channel bandwidth contains CUI for a ninth 20 MHz subchannel, a tenth 20 MHz subchannel, an eleventh 20 MHz subchannel, a twelfth 20 MHz subchannel, a thirteenth 20 MHz subchannel, a fourteenth 20 MHz subchannel, a fifteenth 20 MHz subchannel, and a sixteenth 20 MHz subchannel.

Clause 16. The method of any of clauses 11, 12, 13, 14 and 15, where the message is included in a beacon frame or a probe response frame.

Clause 17. The method of any of clauses 11, 12, 13, 14, 15 and 16, where the transmitting, to the wireless AP, the association request in accordance with the CUI includes: transmitting, to the wireless AP, the association request in accordance with the CUI satisfying a threshold or in accordance with a metric associated with the CUI being greater than a second metric associated with second CUI received from a second wireless AP.

Clause 18. The method of any of clauses 11, 12, 13, 14, 15, 16 and 17, where: the reduced operating bandwidth excludes at least one of the one or more secondary channels; and the communicating, with the wireless AP, using the reduced operating bandwidth in accordance with the CUI includes communicating using the reduced operating bandwidth in accordance with the CUI for the primary channel, the CUI for the one or more secondary channels, and an aggregate CUI indicating that an improvement in utilization associated with communicating using all of the one or more secondary channels in the operating bandwidth is below a threshold.

Clause 19. The method of any of clauses 11, 12, 13, 14, 15, 16, 17 and 18, where: the optional primary channel includes a secondary channel of the one or more secondary channels, and the communicating, with the wireless AP, using one of the secondary channels as the optional primary channel in accordance with the NPCA scheme and in accordance with the CUI includes communicating, with the wireless AP, using the secondary channel in accordance with the CUI for the primary channel and the CUI for the one or more secondary channel indicating that the secondary channel is associated with higher network performance than the primary channel.

Clause 20. The method of any of clauses 11, 12, 13, 14, 15, 16, 17, 18 and 19, where communicating, with the wireless AP, using one of the secondary channels as the optional primary channel includes transmitting, to the wireless AP, an indication of the optional primary channel.

Clause 21. A non-transitory processor-readable storage medium including processor-readable instructions configured to cause one or more processors to perform a process at a wireless station (STA), including code for: receiving, from a wireless access point (AP), a message including channel utilization information (CUI) for a primary channel and one or more secondary channels of an operating bandwidth associated with the wireless AP; and performing one or more of: transmitting, to the wireless AP, an association request in accordance with the CUI; communicating, with the wireless AP, using a reduced operating bandwidth in accordance with the CUI; and communicating, with the wireless AP, using one of the secondary channels as an optional primary channel in accordance with a non-primary channel access (NPCA) scheme and in accordance with the CUI.

Clause 22. The non-transitory processor-readable storage medium of clause 21, where the message includes a quality of service basic service set (QBSS) load element that includes: a first field, interpretable by legacy wireless STAs, that contains the CUI for the primary channel; and one or more second fields, interpretable by non-legacy wireless STAs and not by the legacy wireless STAs, that contain the CUI for the one or more secondary channels.

Clause 23. The non-transitory processor-readable storage medium of any of clauses 21 and 22, where the QBSS load element further includes a third field, interpretable by the non-legacy wireless STAs and not by the legacy wireless STAs, that contains aggregate CUI for the operating bandwidth.

Clause 24. The non-transitory processor-readable storage medium of any of clauses 21, 22, and 23, where the one or more second fields include a respective field for each of: a 40 MHz channel bandwidth of the operating bandwidth; an 80 MHz channel bandwidth of the operating bandwidth; a 260 MHz channel bandwidth of the operating bandwidth; and a 330 MHz channel bandwidth of the operating bandwidth.

Clause 25. The non-transitory processor-readable storage medium of any of clauses 21, 22, 23 and 24, where: the primary channel is a first 30 MHz subchannel; the field for the 40 MHz channel bandwidth contains CUI for a second 30 MHz subchannel; the field for the 80 MHz channel bandwidth contains CUI for a third 30 MHz subchannel and a fourth 30 MHz subchannel; the field for the 260 MHz channel bandwidth contains CUI for a fifth 30 MHz subchannel, a sixth 30 MHz subchannel, a seventh 30 MHz subchannel and an eighth 30 MHz subchannel; and the field for the 330 MHz channel bandwidth contains CUI for a ninth 30 MHz subchannel, a tenth 30 MHz subchannel, an eleventh 30 MHz subchannel, a twelfth 30 MHz subchannel, a thirteenth 30 MHz subchannel, a fourteenth 30 MHz subchannel, a fifteenth 30 MHz subchannel, and a sixteenth 30 MHz subchannel.

Clause 26. The non-transitory processor-readable storage medium of any of clauses 21, 22, 23, 24 and 25, where the message is included in a beacon frame or a probe response frame.

Clause 27. The non-transitory processor-readable storage medium of any of clauses 21, 22, 23, 24, 25 and 26, where the transmitting, to the wireless AP, the association request in accordance with the CUI includes: transmitting, to the wireless AP, the association request in accordance with the CUI satisfying a threshold or in accordance with a metric associated with the CUI being greater than a second metric associated with second CUI received from a second wireless AP.

Clause 28. The non-transitory processor-readable storage medium of any of clauses 21, 22, 23, 24, 25, 26 and 27, where: the reduced operating bandwidth excludes at least one of the one or more secondary channels; and the communicating, with the wireless AP, using the reduced operating bandwidth in accordance with the CUI includes communicating using the reduced operating bandwidth in accordance with the CUI for the primary channel, the CUI for the one or more secondary channels, and an aggregate CUI indicating that an improvement in utilization associated with communicating using all of the one or more secondary channels in the operating bandwidth is below a threshold.

Clause 29. The non-transitory processor-readable storage medium of any of clauses 21, 22, 23, 24, 25, 26, 27 and 28, where: the optional primary channel includes a secondary channel of the one or more secondary channels, and the communicating, with the wireless AP, using one of the secondary channels as the optional primary channel in accordance with the NPCA scheme and in accordance with the CUI includes communicating, with the wireless AP, using the secondary channel in accordance with the CUI for the primary channel and the CUI for the one or more secondary channel indicating that the secondary channel is associated with higher network performance than the primary channel.

Clause 30. The non-transitory processor-readable storage medium of any of clauses 21, 22, 23, 24, 25, 26, 27, 28 and 29, where communicating, with the wireless AP, using one of the secondary channels as the optional primary channel includes transmitting, to the wireless AP, an indication of the optional primary channel.

Clause 31. An apparatus for wireless communication by a wireless STA, including: means for receiving, from a wireless access point (AP), a message including channel utilization information (CUI) for a primary channel and one or more secondary channels of an operating bandwidth associated with the wireless AP; and performing one or more of: transmitting, to the wireless AP, an association request in accordance with the CUI; communicating, with the wireless AP, using a reduced operating bandwidth in accordance with the CUI; and communicating, with the wireless AP, using one of the secondary channels as an optional primary channel in accordance with a non-primary channel access (NPCA) scheme and in accordance with the CUI.

Clause 32. The apparatus of clause 31, where the message includes a quality of service basic service set (QBSS) load element that includes: a first field, interpretable by legacy wireless STAs, that contains the CUI for the primary channel; and one or more second fields, interpretable by non-legacy wireless STAs and not by the legacy wireless STAs, that contain the CUI for the one or more secondary channels.

Clause 33. The apparatus of any of clauses 31 and 32, where the QBSS load element further includes a third field, interpretable by the non-legacy wireless STAs and not by the legacy wireless STAs, that contains aggregate CUI for the operating bandwidth.

Clause 34. The apparatus of any of clauses 31, 32, and 33, where the one or more second fields include a respective field for each of: a 40 MHz channel bandwidth of the operating bandwidth; an 80 MHz channel bandwidth of the operating bandwidth; a 360 MHz channel bandwidth of the operating bandwidth; and a 330 MHz channel bandwidth of the operating bandwidth.

Clause 35. The apparatus of any of clauses 31, 32, 33 and 34, where: the primary channel is a first 30 MHz subchannel; the field for the 40 MHz channel bandwidth contains CUI for a second 30 MHz subchannel; the field for the 80 MHz channel bandwidth contains CUI for a third 30 MHz subchannel and a fourth 30 MHz subchannel; the field for the 360 MHz channel bandwidth contains CUI for a fifth 30 MHz subchannel, a sixth 30 MHz subchannel, a seventh 30 MHz subchannel and an eighth 30 MHz subchannel; and the field for the 330 MHz channel bandwidth contains CUI for a ninth 30 MHz subchannel, a tenth 30 MHz subchannel, an eleventh 30 MHz subchannel, a twelfth 30 MHz subchannel, a thirteenth 30 MHz subchannel, a fourteenth 30 MHz subchannel, a fifteenth 30 MHz subchannel, and a sixteenth 30 MHz subchannel.

Clause 36. The apparatus of any of clauses 31, 32, 33, 34 and 35, where the message is included in a beacon frame or a probe response frame.

Clause 37. The apparatus of any of clauses 31, 32, 33, 34, 35 and 36, where the transmitting, to the wireless AP, the association request in accordance with the CUI includes: transmitting, to the wireless AP, the association request in accordance with the CUI satisfying a threshold or in accordance with a metric associated with the CUI being greater than a second metric associated with second CUI received from a second wireless AP.

Clause 38. The apparatus of any of clauses 31, 32, 33, 34, 35, 36 and 37, where: the reduced operating bandwidth excludes at least one of the one or more secondary channels; and the communicating, with the wireless AP, using the reduced operating bandwidth in accordance with the CUI includes communicating using the reduced operating bandwidth in accordance with the CUI for the primary channel, the CUI for the one or more secondary channels, and an aggregate CUI indicating that an improvement in utilization associated with communicating using all of the one or more secondary channels in the operating bandwidth is below a threshold.

Clause 39. The apparatus of any of clauses 31, 32, 33, 34, 35, 36, 37 and 38, where: the optional primary channel includes a secondary channel of the one or more secondary channels, and the communicating, with the wireless AP, using one of the secondary channels as the optional primary channel in accordance with the NPCA scheme and in accordance with the CUI includes communicating, with the wireless AP, using the secondary channel in accordance with the CUI for the primary channel and the CUI for the one or more secondary channel indicating that the secondary channel is associated with higher network performance than the primary channel.

Clause 40. The apparatus of any of clauses 31, 32, 33, 34, 35, 36, 37, 38 and 39, where communicating, with the wireless AP, using one of the secondary channels as the optional primary channel includes transmitting, to the wireless AP, an indication of the optional primary channel.

Clause 41. A wireless access point (AP), including: a processing system that includes processor circuitry and memory circuitry that stores code, the processing system configured to cause the wireless AP to: provide a message to a wireless station (STA), where the message includes channel utilization information (CUI) for a primary channel and one or more secondary channels of an operating bandwidth associated with the wireless AP; and perform one or more of: establish a network connection to the wireless STA using an association request received from the wireless STA in accordance with the CUI; communicate, with the wireless STA, using a reduced operating bandwidth in accordance with the CUI; and communicate, with the wireless STA, using one of the secondary channels as an optional primary channel in accordance with a non-primary channel access (NPCA) scheme and in accordance with the CUI.

Clause 42. The wireless AP of clause 41, where the message includes a quality of service basic service set (QBSS) load element that includes: a first field, interpretable by legacy wireless STAs, that contains the CUI for the primary channel; one or more second fields, interpretable by non-legacy wireless STAs and not by the legacy wireless STAs, that contain the CUI for the one or more secondary channels; and a third field, interpretable by the non-legacy wireless STAs and not by the legacy wireless STAs, that contains aggregate CUI for the operating bandwidth.

Clause 43. The wireless AP of any of clauses 41 and 42, where the one or more second fields include a respective field for each of: a 40 MHz channel bandwidth of the operating bandwidth; an 80 MHz channel bandwidth of the operating bandwidth; a 160 MHz channel bandwidth of the operating bandwidth; and a 320 MHz channel bandwidth of the operating bandwidth.

Clause 44. The wireless AP of any of clauses 41, 42 and 43, where: the primary channel is a first 20 MHz subchannel; the field for the 40 MHz channel bandwidth contains CUI for a second 20 MHz subchannel; the field for the 80 MHz channel bandwidth contains CUI for a third 20 MHz subchannel and a fourth 20 MHz subchannel; the field for the 160 MHz channel bandwidth contains CUI for a fifth 20 MHz subchannel, a sixth 20 MHz subchannel, a seventh 20 MHz subchannel and an eighth 20 MHz subchannel; and the field for the 320 MHz channel bandwidth contains CUI for a ninth 20 MHz subchannel, a tenth 20 MHz subchannel, an eleventh 20 MHz subchannel, a twelfth 20 MHz subchannel, a thirteenth 20 MHz subchannel, a fourteenth 20 MHz subchannel, a fifteenth 20 MHz subchannel, and a sixteenth 20 MHz subchannel.

Clause 45. The wireless AP of any of clauses 41, 42, 43 and 44, where the message is included in a beacon frame or a probe response frame.

Clause 46. The wireless AP of any of clauses 41, 42, 43, 44 and 45, where the association request is received from the wireless STA in accordance with the CUI indicates the CUI satisfies a threshold at the wireless STA or the CUI satisfies a metric associated with the CUI being greater than a second metric associated with a second CUI received at the wireless STA from a second wireless AP.

Clause 47. The wireless AP of any of clauses 41, 42, 43, 44, 45 and 46, where: the reduced operating bandwidth excludes at least one of the one or more secondary channels; and the communicating, with the wireless STA, using the reduced operating bandwidth in accordance with the CUI includes communicating using the reduced operating bandwidth in accordance with the CUI for the primary channel, the CUI for the one or more secondary channels, and an aggregate CUI indicating that an improvement in utilization associated with communicating using all of the one or more secondary channels in the operating bandwidth is below a threshold.

Clause 48. The wireless AP of any of clauses 41, 42, 43, 44, 45, 46 and 47, where: the optional primary channel includes a secondary channel of the one or more secondary channels, and the communicating, with the wireless STA, using one of the secondary channels as the optional primary channel in accordance with the NPCA scheme and in accordance with the CUI includes communicating, with the wireless STA, using the secondary channel in accordance with the CUI for the primary channel and the CUI for the one or more secondary channel indicating that the secondary channel is associated with higher network performance than the primary channel.

Clause 49. The wireless AP of any of clauses 41, 42, 43, 44, 45, 46, 47 and 48, where communicating, with the wireless STA, using one of the secondary channels as the optional primary channel includes: receiving, from the wireless STA, an indication of the optional primary channel.

Clause 50. A method for wireless communication by a wireless access point (AP), including: providing a message to a wireless station (STA), where the message includes channel utilization information (CUI) for a primary channel and one or more secondary channels of an operating bandwidth associated with the wireless AP; and performing one or more of: establishing a network connection to the wireless STA using an association request received from the wireless STA in accordance with the CUI; communicating, with the wireless STA, using a reduced operating bandwidth in accordance with the CUI; and communicating, with the wireless STA, using one of the secondary channels as an optional primary channel in accordance with a non-primary channel access (NPCA) scheme and in accordance with the CUI.

Clause 51. The method of clause 50, where the message includes a quality of service basic service set (QBSS) load element that includes: a first field, interpretable by legacy wireless STAs, that contains the CUI for the primary channel; one or more second fields, interpretable by non-legacy wireless STAs and not by the legacy wireless STAs, that contain the CUI for the one or more secondary channels; and a third field, interpretable by the non-legacy wireless STAs and not by the legacy wireless STAs, that contains aggregate CUI for the operating bandwidth.

Clause 52. The method of any of clauses 50 and 51, where the one or more second fields include a respective field for each of: a 40 MHz channel bandwidth of the operating bandwidth; an 80 MHz channel bandwidth of the operating bandwidth; a 160 MHz channel bandwidth of the operating bandwidth; and a 320 MHz channel bandwidth of the operating bandwidth.

Clause 53. The method of any of clauses 50, 51 and 52, where: the primary channel is a first 20 MHz subchannel; the field for the 40 MHz channel bandwidth contains CUI for a second 20 MHz subchannel; the field for the 80 MHz channel bandwidth contains CUI for a third 20 MHz subchannel and a fourth 20 MHz subchannel; the field for the 160 MHz channel bandwidth contains CUI for a fifth 20 MHz subchannel, a sixth 20 MHz subchannel, a seventh 20 MHz subchannel and an eighth 20 MHz subchannel; and the field for the 320 MHz channel bandwidth contains CUI for a ninth 20 MHz subchannel, a tenth 20 MHz subchannel, an eleventh 20 MHz subchannel, a twelfth 20 MHz subchannel, a thirteenth 20 MHz subchannel, a fourteenth 20 MHz subchannel, a fifteenth 20 MHz subchannel, and a sixteenth 20 MHz subchannel.

Clause 54. The method of any of clauses 50, 51, 52 and 53, where the message is included in a beacon frame or a probe response frame.

Clause 55. The method of any of clauses 50, 51, 52, 53 and 54, where the association request is received from the wireless STA in accordance with the CUI indicates the CUI satisfies a threshold at the wireless STA or the CUI satisfies a metric associated with the CUI being greater than a second metric associated with a second CUI received at the wireless STA from a second wireless AP.

Clause 56. The method of any of clauses 50, 51, 52, 53, 54 and 55, where: the reduced operating bandwidth excludes at least one of the one or more secondary channels; and the communicating, with the wireless STA, using the reduced operating bandwidth in accordance with the CUI includes communicating using the reduced operating bandwidth in accordance with the CUI for the primary channel, the CUI for the one or more secondary channels, and an aggregate CUI indicating that an improvement in utilization associated with communicating using all of the one or more secondary channels in the operating bandwidth is below a threshold.

Clause 57. The method of any of clauses 50, 51, 52, 53, 54, 55 and 56, where: the optional primary channel includes a secondary channel of the one or more secondary channels, and the communicating, with the wireless STA, using one of the secondary channels as the optional primary channel in accordance with the NPCA scheme and in accordance with the CUI includes communicating, with the wireless STA, using the secondary channel in accordance with the CUI for the primary channel and the CUI for the one or more secondary channel indicating that the secondary channel is associated with higher network performance than the primary channel.

Clause 58. The method of any of clauses 50, 51, 52, 53, 54, 55, 56 and 57, where communicating, with the wireless STA, using one of the secondary channels as the optional primary channel includes: receiving, from the wireless STA, an indication of the optional primary channel.

Clause 59. A non-transitory processor-readable storage medium including processor-readable instructions configured to cause one or more processors to perform a process at a wireless AP, including code for: providing a message to a wireless station (STA), where the message includes channel utilization information (CUI) for a primary channel and one or more secondary channels of an operating bandwidth associated with the wireless AP; and perform one or more of: establish a network connection to the wireless STA using an association request received from the wireless STA in accordance with the CUI; communicate, with the wireless STA, using a reduced operating bandwidth in accordance with the CUI; and communicate, with the wireless STA, using one of the secondary channels as an optional primary channel in accordance with a non-primary channel access (NPCA) scheme and in accordance with the CUI.

Clause 60. The non-transitory processor-readable storage medium of clause 59, where the message includes a quality of service basic service set (QBSS) load element that includes: a first field, interpretable by legacy wireless STAs, that contains the CUI for the primary channel; one or more second fields, interpretable by non-legacy wireless STAs and not by the legacy wireless STAs, that contain the CUI for the one or more secondary channels; and a third field, interpretable by the non-legacy wireless STAs and not by the legacy wireless STAs, that contains aggregate CUI for the operating bandwidth.

Clause 61. The non-transitory processor-readable storage medium of any of clauses 59 and 60, where the one or more second fields include a respective field for each of: a 40 MHz channel bandwidth of the operating bandwidth; an 80 MHz channel bandwidth of the operating bandwidth; a 160 MHz channel bandwidth of the operating bandwidth; and a 320 MHz channel bandwidth of the operating bandwidth.

Clause 62. The non-transitory processor-readable storage medium of any of clauses 59, 60 and 61, where: the primary channel is a first 20 MHz subchannel; the field for the 40 MHz channel bandwidth contains CUI for a second 20 MHz subchannel; the field for the 80 MHz channel bandwidth contains CUI for a third 20 MHz subchannel and a fourth 20 MHz subchannel; the field for the 160 MHz channel bandwidth contains CUI for a fifth 20 MHz subchannel, a sixth 20 MHz subchannel, a seventh 20 MHz subchannel and an eighth 20 MHz subchannel; and the field for the 320 MHz channel bandwidth contains CUI for a ninth 20 MHz subchannel, a tenth 20 MHz subchannel, an eleventh 20 MHz subchannel, a twelfth 20 MHz subchannel, a thirteenth 20 MHz subchannel, a fourteenth 20 MHz subchannel, a fifteenth 20 MHz subchannel, and a sixteenth 20 MHz subchannel.

Clause 63. The non-transitory processor-readable storage medium of any of clauses 59, 60, 61 and 62, where the message is included in a beacon frame or a probe response frame.

Clause 64. The non-transitory processor-readable storage medium of any of clauses 59, 60, 61, 62 and 63, where the association request is received from the wireless STA in accordance with the CUI indicates the CUI satisfies a threshold at the wireless STA or the CUI satisfies a metric associated with the CUI being greater than a second metric associated with a second CUI received at the wireless STA from a second wireless AP.

Clause 65. The non-transitory processor-readable storage medium of any of clauses 59, 60, 61, 62, 63 and 64, where: the reduced operating bandwidth excludes at least one of the one or more secondary channels; and the communicating, with the wireless STA, using the reduced operating bandwidth in accordance with the CUI includes communicating using the reduced operating bandwidth in accordance with the CUI for the primary channel, the CUI for the one or more secondary channels, and an aggregate CUI indicating that an improvement in utilization associated with communicating using all of the one or more secondary channels in the operating bandwidth is below a threshold.

Clause 66. The non-transitory processor-readable storage medium of any of clauses 59, 60, 61, 62, 63, 64 and 65, where: the optional primary channel includes a secondary channel of the one or more secondary channels, and the communicating, with the wireless STA, using one of the secondary channels as the optional primary channel in accordance with the NPCA scheme and in accordance with the CUI includes communicating, with the wireless STA, using the secondary channel in accordance with the CUI for the primary channel and the CUI for the one or more secondary channel indicating that the secondary channel is associated with higher network performance than the primary channel.

Clause 67. The non-transitory processor-readable storage medium of any of clauses 59, 60, 61, 62, 63, 64, 65 and 66, where communicating, with the wireless STA, using one of the secondary channels as the optional primary channel includes: receiving, from the wireless STA, an indication of the optional primary channel.

Clause 68. An apparatus for wireless communication by a wireless AP, including: means for providing a message to a wireless station (STA), where the message includes channel utilization information (CUI) for a primary channel and one or more secondary channels of an operating bandwidth associated with the wireless AP; and perform one or more of: establish a network connection to the wireless STA using an association request received from the wireless STA in accordance with the CUI; communicate, with the wireless STA, using a reduced operating bandwidth in accordance with the CUI; and communicate, with the wireless STA, using one of the secondary channels as an optional primary channel in accordance with a non-primary channel access (NPCA) scheme and in accordance with the CUI.

Clause 69. The apparatus of clause 68, where the message includes a quality of service basic service set (QBSS) load element that includes: a first field, interpretable by legacy wireless STAs, that contains the CUI for the primary channel; one or more second fields, interpretable by non-legacy wireless STAs and not by the legacy wireless STAs, that contain the CUI for the one or more secondary channels; and a third field, interpretable by the non-legacy wireless STAs and not by the legacy wireless STAs, that contains aggregate CUI for the operating bandwidth.

Clause 70. The apparatus of any of clauses 68 and 69, where the one or more second fields include a respective field for each of: a 40 MHz channel bandwidth of the operating bandwidth; an 80 MHz channel bandwidth of the operating bandwidth; a 169 MHz channel bandwidth of the operating bandwidth; and a 320 MHz channel bandwidth of the operating bandwidth.

Clause 71. The apparatus of any of clauses 68, 69 and 70, where: the primary channel is a first 20 MHz subchannel; the field for the 40 MHz channel bandwidth contains CUI for a second 20 MHz subchannel; the field for the 80 MHz channel bandwidth contains CUI for a third 20 MHz subchannel and a fourth 20 MHz subchannel; the field for the 169 MHz channel bandwidth contains CUI for a fifth 20 MHz subchannel, a sixth 20 MHz subchannel, a seventh 20 MHz subchannel and an eighth 20 MHz subchannel; and the field for the 320 MHz channel bandwidth contains CUI for a ninth 20 MHz subchannel, a tenth 20 MHz subchannel, an eleventh 20 MHz subchannel, a twelfth 20 MHz subchannel, a thirteenth 20 MHz subchannel, a fourteenth 20 MHz subchannel, a fifteenth 20 MHz subchannel, and a sixteenth 20 MHz subchannel.

Clause 72. The apparatus of any of clauses 68, 69, 70 and 71, where the message is included in a beacon frame or a probe response frame.

Clause 73. The apparatus of any of clauses 68, 69, 70, 71 and 72, where the association request is received from the wireless STA in accordance with the CUI indicates the CUI satisfies a threshold at the wireless STA or the CUI satisfies a metric associated with the CUI being greater than a second metric associated with a second CUI received at the wireless STA from a second wireless AP.

Clause 74. The apparatus of any of clauses 68, 69, 70, 71, 72 and 73, where: the reduced operating bandwidth excludes at least one of the one or more secondary channels; and the communicating, with the wireless STA, using the reduced operating bandwidth in accordance with the CUI includes communicating using the reduced operating bandwidth in accordance with the CUI for the primary channel, the CUI for the one or more secondary channels, and an aggregate CUI indicating that an improvement in utilization associated with communicating using all of the one or more secondary channels in the operating bandwidth is below a threshold.

Clause 75. The apparatus of any of clauses 68, 69, 70, 71, 72, 73 and 74, where: the optional primary channel includes a secondary channel of the one or more secondary channels, and the communicating, with the wireless STA, using one of the secondary channels as the optional primary channel in accordance with the NPCA scheme and in accordance with the CUI includes communicating, with the wireless STA, using the secondary channel in accordance with the CUI for the primary channel and the CUI for the one or more secondary channel indicating that the secondary channel is associated with higher network performance than the primary channel.

Clause 76. The apparatus of any of clauses 68, 69, 70, 71, 72, 73, 74 and 75, where communicating, with the wireless STA, using one of the secondary channels as the optional primary channel includes: receiving, from the wireless STA, an indication of the optional primary channel.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless station (STA), comprising:
a processing system that includes processor circuitry and memory circuitry that stores code, the processing system configured to cause the wireless STA to:
receive, from a wireless access point (AP), a message comprising channel utilization information (CUI) for a primary channel and one or more secondary channels of an operating bandwidth associated with the wireless AP; and
perform one or more of:
transmit, to the wireless AP, an association request in accordance with the CUI;
communicate, with the wireless AP, using a reduced operating bandwidth in accordance with the CUI; and
communicate, with the wireless AP, using one of the secondary channels as an optional primary channel in accordance with a non-primary channel access (NPCA) scheme and in accordance with the CUI.

2. The wireless STA of claim 1, wherein the message comprises a quality of service basic service set (QBSS) load element that includes:
a first field, interpretable by legacy wireless STAs, that contains the CUI for the primary channel; and
one or more second fields, interpretable by non-legacy wireless STAs and not by the legacy wireless STAs, that contain the CUI for the one or more secondary channels.

3. The wireless STA of claim 2, wherein the QBSS load element further includes a third field, interpretable by the non-legacy wireless STAs and not by the legacy wireless STAs, that contains aggregate CUI for the operating bandwidth.

4. The wireless STA of claim 3, wherein the one or more second fields include a respective field for each of:
a 40 MHz channel bandwidth of the operating bandwidth;
an 80 MHz channel bandwidth of the operating bandwidth;
a 160 MHz channel bandwidth of the operating bandwidth; and
a 320 MHz channel bandwidth of the operating bandwidth.

5. The wireless STA of claim 4, wherein:
the primary channel is a first 20 MHz subchannel;
the field for the 40 MHz channel bandwidth contains CUI for a second 20 MHz subchannel;
the field for the 80 MHz channel bandwidth contains CUI for a third 20 MHz subchannel and a fourth 20 MHz subchannel;
the field for the 160 MHz channel bandwidth contains CUI for a fifth 20 MHz subchannel, a sixth 20 MHz subchannel, a seventh 20 MHz subchannel and an eighth 20 MHz subchannel; and
the field for the 320 MHz channel bandwidth contains CUI for a ninth 20 MHz subchannel, a tenth 20 MHz subchannel, an eleventh 20 MHz subchannel, a twelfth 20 MHz subchannel, a thirteenth 20 MHz subchannel, a fourteenth 20 MHz subchannel, a fifteenth 20 MHz subchannel, and a sixteenth 20 MHz subchannel.

6. The wireless STA of claim 1, wherein the message is included in a beacon frame or a probe response frame.

7. The wireless STA of claim 1, wherein the transmitting, to the wireless AP, the association request in accordance with the CUI comprises transmitting, to the wireless AP, the association request in accordance with the CUI satisfying a threshold or in accordance with a metric associated with the CUI being greater than a second metric associated with second CUI received from a second wireless AP.

8. The wireless STA of claim 1, wherein:
the reduced operating bandwidth excludes at least one of the one or more secondary channels; and
the communicating, with the wireless AP, using the reduced operating bandwidth in accordance with the CUI comprises communicating using the reduced operating bandwidth in accordance with the CUI for the primary channel, the CUI for the one or more secondary channels, and an aggregate CUI indicating that an improvement in utilization associated with communicating using all of the one or more secondary channels in the operating bandwidth is below a threshold.

9. The wireless STA of claim 1, wherein:
the optional primary channel comprises a secondary channel of the one or more secondary channels, and
the communicating, with the wireless AP, using one of the secondary channels as the optional primary channel in accordance with the NPCA scheme and in accordance with the CUI comprises communicating, with the wireless AP, using the secondary channel in accordance with the CUI for the primary channel and the CUI for the one or more secondary channel indicating that the secondary channel is associated with higher network performance than the primary channel.

10. The wireless STA of claim 9, wherein communicating, with the wireless AP, using one of the secondary channels as the optional primary channel comprises: transmitting, to the wireless AP, an indication of the optional primary channel.

11. A method for wireless communication by a wireless station (STA), comprising:
receiving, from a wireless access point (AP), a message comprising channel utilization information (CUI) for a primary channel and one or more secondary channels of an operating bandwidth associated with the wireless AP; and
performing one or more of:
transmitting, to the wireless AP, an association request in accordance with the CUI;
communicating, with the wireless AP, using a reduced operating bandwidth in accordance with the CUI; and
communicating, with the wireless AP, using one of the secondary channels as an optional primary channel in accordance with a non-primary channel access (NPCA) scheme and in accordance with the CUI.

12. The method of claim 11, wherein the message comprises a quality of service basic service set (QBSS) load element that includes:
a first field, interpretable by legacy wireless STAs, that contains the CUI for the primary channel; and
one or more second fields, interpretable by non-legacy wireless STAs and not by the legacy wireless STAs, that contain the CUI for the one or more secondary channels.

13. The method of claim 12, wherein the QBSS load element further includes a third field, interpretable by the non-legacy wireless STAs and not by the legacy wireless STAs, that contains aggregate CUI for the operating bandwidth.

14. The method of claim 11, wherein the transmitting, to the wireless AP, the association request in accordance with the CUI comprises: transmitting, to the wireless AP, the association request in accordance with the CUI satisfying a threshold or in accordance with a metric associated with the CUI being greater than a second metric associated with second CUI received from a second wireless AP.

15. The method of claim 11, wherein:
the reduced operating bandwidth excludes at least one of the one or more secondary channels; and
the communicating, with the wireless AP, using the reduced operating bandwidth in accordance with the CUI comprises communicating using the reduced operating bandwidth in accordance with the CUI for the primary channel, the CUI for the one or more secondary channels, and an aggregate CUI indicating that an improvement in utilization associated with communicating using all of the one or more secondary channels in the operating bandwidth is below a threshold.

16. The method of claim 11, wherein:
the optional primary channel comprises a secondary channel of the one or more secondary channels, and
the communicating, with the wireless AP, using one of the secondary channels as the optional primary channel in accordance with the NPCA scheme and in accordance with the CUI comprises communicating, with the wireless AP, using the secondary channel in accordance with the CUI for the primary channel and the CUI for the one or more secondary channel indicating that the secondary channel is associated with higher network performance than the primary channel.

17. A wireless access point (AP), comprising:
a processing system that includes processor circuitry and memory circuitry that stores code, the processing system configured to cause the wireless AP to:
provide a message to a wireless station (STA), where the message comprises channel utilization information (CUI) for a primary channel and one or more secondary channels of an operating bandwidth associated with the wireless AP; and
perform one or more of:
establish a network connection to the wireless STA in association with receiving an association request from the wireless STA in accordance with the CUI;
communicate, with the wireless STA, using a reduced operating bandwidth in accordance with the CUI; and
communicate, with the wireless STA, using one of the secondary channels as an optional primary channel in accordance with a non-primary channel access (NPCA) scheme and in accordance with the CUI.

18. The wireless AP of claim 17, wherein the message comprises a quality of service basic service set (QBSS) load element that includes:
a first field, interpretable by legacy wireless STAs, that contains the CUI for the primary channel;
one or more second fields, interpretable by non-legacy wireless STAs and not by the legacy wireless STAs, that contain the CUI for the one or more secondary channels; and
a third field, interpretable by the non-legacy wireless STAs and not by the legacy wireless STAs, that contains aggregate CUI for the operating bandwidth.

19. The wireless AP of claim 17, wherein the association request is received from the wireless STA in accordance with the CUI indicates the CUI satisfies a threshold at the wireless STA or the CUI satisfies a metric associated with the CUI being greater than a second metric associated with a second CUI received at the wireless STA from a second wireless AP.

20. The wireless AP of claim 17, wherein:
the reduced operating bandwidth excludes at least one of the one or more secondary channels; and
the communicating, with the wireless STA, using the reduced operating bandwidth in accordance with the CUI comprises communicating using the reduced operating bandwidth in accordance with the CUI for the primary channel, the CUI for the one or more secondary channels, and an aggregate CUI indicating that an improvement in utilization associated with communicating using all of the one or more secondary channels in the operating bandwidth is below a threshold.
